(19) United States
(12) Patent Application Publication
(10) Pub. No.: US 2026/0115515 A1
(43) Pub. Date: Apr. 30, 2026

(54) FIRE SUPPRESSION APPARATUS

(71) Applicant: Westshire Estates, Irvine, CA (US)

(72) Inventor: Ioan Sorin Ionescu, Irvine, CA (US)

(21) Appl. No.: 19/368,195

(22) Filed: Oct. 24, 2025

Related U.S. Application Data
(60) Provisional application No. 63/711,441, filed on Oct. 24, 2024.

(51) Int. Cl. A62C 37/36; A62C 2/06; A62C 3/02; A62C 35/68

(52) U.S. Cl. CPC A62C 37/36; A62C 3/0264; A62C 3/14; A62C 35/68

(57) ABSTRACT

A fire suppression apparatus having a control base having a solenoid valve configured to be in fluid communication with a water supply, and a pump configured to be in fluid communication with the solenoid valve, a distribution line in fluid communication with the pump, a nozzle in fluid communication with the distribution line, wherein the nozzle is configured to emit a water curtain, and a flame sensor in electrical communication with the control base, wherein the flame sensor is configured to send a signal to the control base to open the solenoid valve and activate the pump upon detecting a flame, such that water from the water supply is pumped through the distribution line and emitted through the nozzle. Each water curtain may have a compact region configured to be impermeable to gases which may cover an opening in a building to slow or prevent the spread of a fire.

### CROSS-REFERENCE TO RELATED APPLICATIONS

This application claims priority to U.S. Provisional Application No. 63/711,441, filed Oct. 24, 2024, which is hereby incorporated by reference, to the extent that it is not conflicting with the present application.

### BACKGROUND OF INVENTION

### 1. Field of the Invention

The invention relates generally to fire suppression apparatuses and specifically to fire suppression apparatuses configured to contain a fire within a structure and prevent the spread of the fire to other structures.

### 2. Description of the Related Art

Fires pose a significant threat to the stability of structures, as well as the health and safety of their inhabitants, particularly in environments having high building density, such as in cities, wherein buildings are in close proximity to each other. In said urban environment, a fire may begin in a first building and spread quickly to adjacent buildings. As a first building burns, fire may begin to escape out of broken windows destroyed by the fire, naturally occurring gaps within the structure (e.g., door gaps), and the roof, as the fire becomes larger. This may allow fires to spread rapidly to adjacent structures. Furthermore, the fire within a structure may continue to feed off of the surrounding air though broken windows, gaps in structures, etc., to maintain itself and continue burning. This spread of fire to adjacent structures can be particularly difficult to contain as more structures begin to ignite. This issue may be exacerbated during drier environmental conditions, wherein ignited materials may travel on the wind to ignite other more distant structures.

While currently available fire extinguishing mechanisms, such as standard internal sprinkler systems, may be widely used within the industry, said mechanisms are often incapable of preventing the spread and growth of larger fires. These fires are still able to pull in oxygen from the external environment through gaps in door structures, broken windows, etc., to maintain the fire, and may thus still grow out of control even when suppressed by a standard internal sprinkler system. Furthermore, standard internal sprinkler systems may not be capable of protecting windows from being destroyed by a fire, and thus windows may be broken due to their increased temperatures, and the growing internal pressure within the building, allowing more oxygen to be pulled in from the external environment and more smoke, flames and burning debris to escape the burning building into the external environment.

Therefore, there is a need to solve the problems described above by proving a device and method for detecting and suppressing fires to prevent them from spreading to other structures.

The aspects or the problems and the associated solutions presented in this section could be or could have been pursued; they are not necessarily approaches that have been previously conceived or pursued. It should be understood that structural and/or logical modifications could be made by someone of ordinary skills in the art without departing from the scope of the invention. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, a fire suppression apparatus configured to be associated with a building is provided, the fire suppression apparatus comprising: a main control base having: a solenoid valve configured to be in fluid communication with a water supply; a pump configured to be in fluid communication with the solenoid valve; and a connection box in electrical communication with the solenoid valve and the pump; a distribution line in fluid communication with the pump; a plurality of nozzles in fluid communication with the distribution line, wherein each nozzle is configured to emit a water curtain; and a plurality of flame sensors in electrical communication with the connection box, wherein each flame sensor of the plurality of flame sensors is configured to monitor a corresponding portion of the building and further configured to send a signal to the connection box to selectively open the solenoid valve and activate the pump upon detection of a flame, such that water from the water supply is selectively pumped through the distribution line and emitted through each nozzle. Thus, an advantage is that the fire suppression apparatus may be configured to utilize an available municipal water supply in order to provide each nozzle with pressurized water for the creation of a corresponding water curtain. Another advantage is that each water curtain produced by the fire suppression apparatus is configured to block fires within a burning structure from traveling to adjacent structures by creating a compact water curtain in each building opening, as well as on the roof. Each produced water curtain is also configured such that gases, smoke and flames cannot pass through it, thus preventing burning materials and smoke from leaving the burning building on which the fire suppression system is installed, while also slowing the flow of oxygen into the burning building from the external environment. This in turn helps to contain a fire within a building for longer, providing additional time for the fire brigade/fire department to arrive at the scene by slowing the potential growth of the fire. Another advantage is that each disclosed nozzle may be configured to utilize less water than conventionally utilized sprinklers, while still providing optimal fire suppression to avoid the proliferation of fire to adjacent structures. Another advantage is that the disclosed fire suppression apparatus may be configured to operate autonomously (without human intervention), wherein the flame sensors are configured to send a signal to the main control base to operate the pump and initiate the flow of water to each nozzle, and to stop flow to each nozzle after the fire has been extinguished. The fire suppression apparatus may also alert the building owner and fire brigade of the fire automatically, to ensure that the appropriate parties are aware and able to take action. Another advantage is that each water curtain may be configured to cool a corresponding window, door and other vulnerable structure during a fire, thus allowing the windows, doors and other vulnerable structures to remain intact for longer despite the increased temperature and pressure within the building, thus further slowing the proliferation of the fire from the burning building.

In another aspect, a fire suppression apparatus is provided, the fire suppression apparatus comprising: a main control base having: a solenoid valve configured to be in fluid communication with a water supply; and a pump configured to be in fluid communication with the solenoid valve; a distribution line in fluid communication with the pump; a nozzle in fluid communication with the distribution line, wherein the nozzle is configured to emit a water curtain; and a flame sensor in electrical communication with the main control base, wherein the flame sensor is configured to send a signal to the main control base to selectively open the solenoid valve and activate the pump upon detecting a flame, such that water from the water supply is pumped through the distribution line and emitted through the nozzle. Again, an advantage is that the fire suppression apparatus may be configured to utilize an available municipal water supply in order to provide each nozzle with pressurized water for the creation of a corresponding water curtain. Another advantage is that each water curtain produced by the fire suppression apparatus is configured to block fires within a burning structure from traveling to adjacent structures by creating a compact water curtain in each building opening, as well as on the roof. Each produced water curtain is also configured such that gases, smoke and flames cannot pass through it, thus preventing burning materials and smoke from leaving the burning building on which the fire suppression system is installed, while also slowing the flow of oxygen into the burning building from the external environment. This in turn helps to contain a fire within a building for longer, providing additional time for the fire brigade/fire department to arrive at the scene by slowing the potential growth of the fire. Another advantage is that each disclosed nozzle may be configured to utilize less water than conventionally utilized sprinklers, while still providing optimal fire suppression to avoid the proliferation of fire to adjacent structures. Another advantage is that the disclosed fire suppression apparatus may be configured to operate autonomously (without human intervention), wherein the flame sensors are configured to send a signal to the main control base to operate the pump and initiate the flow of water to each nozzle, and to stop flow to each nozzle after the fire has been extinguished. The fire suppression apparatus may also alert the building owner and fire brigade of the fire automatically, to ensure that the appropriate parties are aware and able to take action. Another advantage is that each water curtain may be configured to cool a corresponding window, door and other vulnerable structure during a fire, thus allowing the windows, doors and other vulnerable structures to remain intact for longer despite the increased temperature and pressure within the building, thus further slowing the proliferation of the fire from the burning building.

In another aspect, a method of operating a fire suppression system is provided, the fire suppression system having: a main control base having: a solenoid valve configured to be in fluid communication with a water supply; and a pump configured to be in fluid communication with the solenoid valve; a distribution line in fluid communication with the pump; a nozzle in fluid communication with the distribution line, wherein the nozzle is configured to emit a water curtain; and a flame sensor in electrical communication with the main control base, wherein the flame sensor is configured to send a signal to the main control base to selectively open the solenoid valve and activate the pump upon detecting a flame, such that water from the water supply is pumped through the distribution line and emitted through the nozzle, the method comprising the steps of: detecting a fire in proximity to the building; sending a signal from the flame sensor to the main control base; actuating the solenoid valve to selectively open fluid communication between the water source and the pump and starting pump operation to pump water through the distribution line to the nozzles; creating a corresponding water curtain from each nozzle of the plurality of nozzles, wherein each water curtain is configured to cover a corresponding portion of the building with a compact water curtain; detecting an absence of fire in proximity to the building; and actuating the solenoid valve to close fluid communication between the water source and the pump and stopping pump operation to cease pumping water through the distribution line. Again, an advantage is that the fire suppression apparatus may be configured to utilize an available municipal water supply in order to provide each nozzle with pressurized water for the creation of a corresponding water curtain. Another advantage is that each water curtain produced by the fire suppression apparatus is configured to block fires within a burning structure from traveling to adjacent structures by creating a compact water curtain in each building opening, as well as on the roof. Each produced water curtain is also configured such that gases, smoke and flames cannot pass through it, thus preventing burning materials and smoke from leaving the burning building on which the fire suppression system is installed, while also slowing the flow of oxygen into the burning building from the external environment. This in turn helps to contain a fire within a building for longer, providing additional time for the fire brigade/fire department to arrive at the scene by slowing the potential growth of the fire. Another advantage is that each disclosed nozzle may be configured to utilize less water than conventionally utilized sprinklers, while still providing optimal fire suppression to avoid the proliferation of fire to adjacent structures. Another advantage is that the disclosed fire suppression apparatus may be configured to operate autonomously (without human intervention), wherein the flame sensors are configured to send a signal to the main control base to operate the pump and initiate the flow of water to each nozzle, and to stop flow to each nozzle after the fire has been extinguished. The fire suppression apparatus may also alert the building owner and fire brigade of the fire automatically, to ensure that the appropriate parties are aware and able to take action. Another advantage is that each water curtain may be configured to cool a corresponding window, door and other vulnerable structure during a fire, thus allowing the windows, doors and other vulnerable structures to remain intact for longer despite the increased temperature and pressure within the building, thus further slowing the proliferation of the fire from the burning building.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments, or examples of the invention are illustrated in the figures of the accompanying drawings, in which:

FIG. 1A illustrates the front perspective view of a main control base of an embodiment of the fire suppression apparatus, according to an aspect.

FIG. 1B illustrates the front perspective view of the main control base of FIG. 1A with the panel cover removed, according to an aspect.

FIG. 2 illustrates the bottom perspective view of a flame sensor of a fire suppression apparatus, according to an aspect.

FIG. 3 illustrates a bottom perspective view of distribution line of a fire suppression apparatus, according to an aspect.

FIG. 4 illustrates the front perspective view of a building having the fire suppression apparatus, according to an aspect.

FIG. 5A-5F illustrate the top perspective, front, back, left, right and top views, respectively, of a building having the fire suppression apparatus installed, according to an aspect.

FIG. 6A illustrates a front view of a static simulation of nozzle operation, according to an aspect.

FIG. 6B illustrates a side view of a static simulation of nozzle operation, according to an aspect.

FIG. 6C illustrates a front perspective view of a static simulation of nozzle operation, according to an aspect.

FIG. 6D illustrates a static temperature simulation of a 200 kW/m² heat load fire in a room after 50 seconds, according to an aspect.

FIG. 6E illustrates a static pressure simulation of a 200 kW/m² heat load fire in a room after 50 seconds, according to an aspect.

FIG. 6F illustrates a static temperature simulation of a 1000 kW/m² heat load fire in a room after 50 seconds, according to an aspect.

FIG. 6G illustrates a static pressure simulation of a 1000 kW/m² heat load fire in a room after 50 seconds, according to an aspect.

FIG. 6H illustrates a graph of pressure over time for the static pressure simulation of a 1000 kW/m² heat load fire in a room of FIG. 7G, according to an aspect.

FIG. 7A illustrates a schematic diagram of a nozzle testing apparatus, according to an aspect.

FIG. 7B illustrates the front view of a nozzle testing apparatus, according to an aspect.

FIG. 7C illustrates the top view of a nozzle testing apparatus, according to an aspect.

FIG. 7D illustrates the front view of a micromanometer prior to operating the nozzle testing apparatus, according to an aspect.

FIG. 7E illustrates the front view of a micromanometer while operating the nozzle testing apparatus, according to an aspect.

FIG. 8A illustrates a table for a first nozzle on the nozzle testing apparatus producing a water curtain, according to an aspect.

FIG. 8B illustrates the side perspective view of the first nozzle on the nozzle testing apparatus producing a water curtain, according to an aspect.

FIG. 8C illustrates a nozzle spray diagram for the first nozzle, according to an aspect.

FIG. 9A illustrates a table for a second nozzle being tested on the nozzle testing apparatus, according to an aspect.

FIG. 9B illustrates the side perspective view of the second nozzle on the nozzle testing apparatus producing a water curtain, according to an aspect.

FIG. 9C illustrates a nozzle spray diagram for the second nozzle, according to an aspect.

FIG. 10A illustrates a table for a third nozzle being tested on the nozzle testing apparatus, according to an aspect.

FIG. 10B illustrates the side perspective view of the third nozzle on the nozzle testing apparatus producing a water curtain, according to an aspect.

FIG. 10C illustrates a nozzle spray diagram for the third nozzle, according to an aspect.

FIG. 11A illustrates a table for a fourth nozzle being tested on the nozzle testing apparatus, according to an aspect.

FIG. 11B illustrates the side perspective view of the fourth nozzle on the nozzle testing apparatus producing a water curtain, according to an aspect.

FIG. 11C illustrates a nozzle spray diagram for the fourth nozzle, according to an aspect.

FIG. 12A illustrates a table for a fifth nozzle being tested on the nozzle testing apparatus, according to an aspect.

FIG. 12B illustrates the side perspective view of the fifth nozzle on the nozzle testing apparatus producing a water curtain, according to an aspect.

FIG. 12C illustrates a nozzle spray diagram for the fifth nozzle, according to an aspect.

FIGS. 13A-13B illustrate the residence times for a water curtain sprayed from a nozzle of the fire suppression apparatus from the front and side views, respectively, according to an aspect.

FIG. 14A illustrates the 1st floor of an experimental configuration for testing the fire suppression apparatus, according to an aspect.

FIG. 14B illustrates the 2nd floor of an experimental configuration for testing the fire suppression apparatus, according to an aspect.

FIG. 14C illustrates the 3rd floor of an experimental configuration for testing the fire suppression apparatus, according to an aspect.

FIG. 14D illustrates a pipe diagram of the experimental configuration of the fire suppression apparatus of FIGS. 14A-14C, according to an aspect.

FIGS. 15A-15C illustrate tables of the functional specifications of the fire suppression apparatus configuration of FIG. 14A-14D, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

It should be understood that, for clarity of the drawings and of the specification, some or all details about some structural components or steps that are known in the art are not shown or described if they are not necessary for the invention to be understood by one of ordinary skills in the art.

For the following description, it can be assumed that most correspondingly labeled elements across the figures (e.g., 811 and 911, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

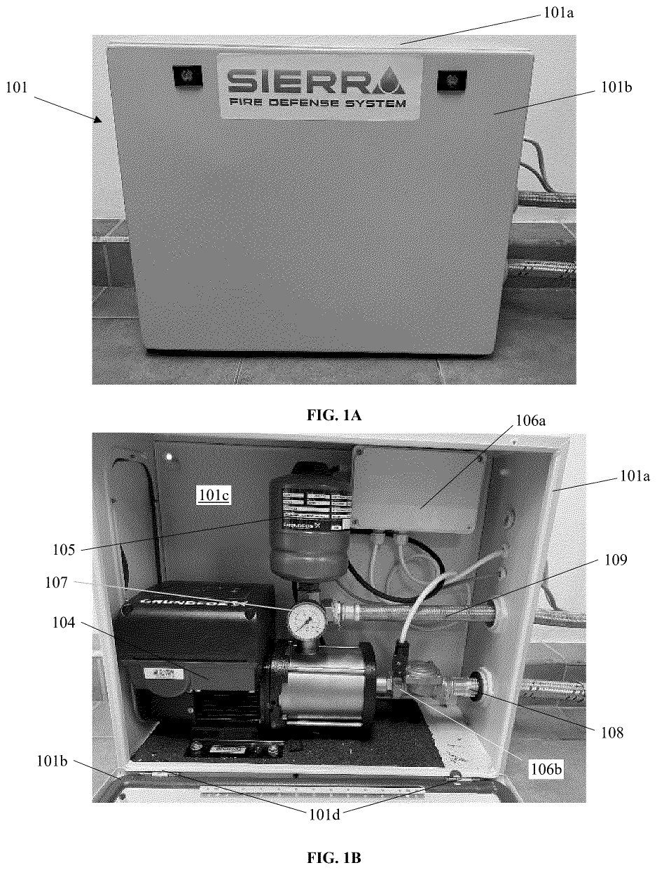

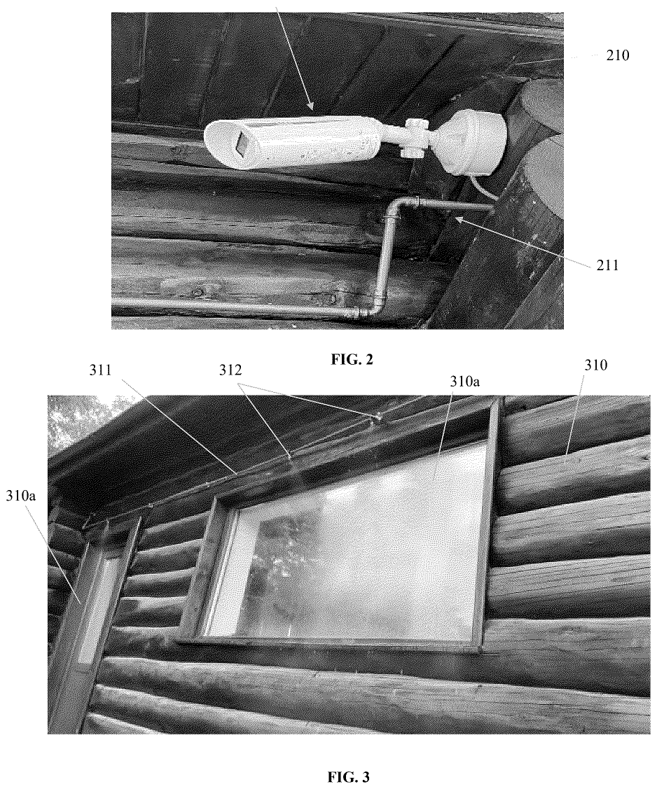

FIG. 1A illustrates the front perspective view of a main control base (“control base”, “base”) 101 of an embodiment of the fire suppression apparatus, according to an aspect. FIG. 1B illustrates the front perspective view of the main control base 101 of FIG. 1A with the panel cover removed, according to an aspect. The fire suppression apparatus (“Sierra-Fire Defense System”) disclosed herein may be supplied to users for installation on their homes or other buildings, wherein the fire suppression apparatus is configured to suppress and contain a fire within the corresponding building, thus slowing or outright preventing the spread of fire to nearby structures, while also protecting the building from fires outside the building. In an embodiment, the fire suppression apparatus may comprise a plurality of interconnected elements, including a main control base 101, at least one fire sensor, such as detection camera 202 of FIG. 2, a distribution line, such as distribution line 303 of FIG. 3, and at least one nozzle, such as nozzle 312 of FIG. 3. The interconnection of these fire suppression apparatus elements will be described in greater detail hereinbelow.

In an embodiment, the main control base 101 of a fire suppression system may be configured to house a plurality of the electronic elements of the fire suppression system that do not require specific placement elsewhere (e.g., the fire sensors need to be able to observe a potential fire on or in the building, and thus need to be positioned appropriately). The main control base 101 may comprise a base body 101a, a base cavity 101c nested within the base body 101a, and a panel cover 101b configured to be selectively engage with the base body 101a, wherein selective engagement of the panel cover 101b with the base body 101a conceals the base cavity 101c (and its contents), as seen in FIG. 1A. As seen in FIG. 1B, the panel cover 101b may be pivotally engaged with the base body 101a by a pair of pivot pins 101d, to allow the panel cover 101b and base body 101a to remain partially connected while the base cavity 101c is exposed.

In an embodiment, the main control base 101 may comprise a plurality of main control base elements configured to be nested within the base cavity 101c. In said embodiment, the main control base elements may include a control pump (“pump”) 104, an expansion tank 105 in fluid communication with the control pump 104, a pressure gauge 107 in fluid communication with the control pump 104, a connection box 106a in electrical communication with the control pump 104 and a solenoid valve 106b configured to be in electrical communication with the connection box 106a and fluid communication with the control pump 104. In an embodiment, the main control base elements may further comprise a flexible intake connection 108 to a municipal water supply configured to be in fluid communication with the solenoid valve 106b and a flexible output connection 109 configured to be in fluid communication with the control pump 104 and a distribution line, such as distribution line 311 of FIG. 3A. In an embodiment, the solenoid valve 106b may be disposed between the flexible intake connection 108 and the pump 104, such that the flow of water between the flexible intake connection 108 and the pump 104 may be controlled using the solenoid valve 106b. In an embodiment, the control pump 104 may be configured to pressurize the incoming water from the flexible input connection 108 to 8.5 bar before sending pumping said water through the flexible output connection 109 to the distribution line of the fire suppression apparatus to the corresponding nozzles.

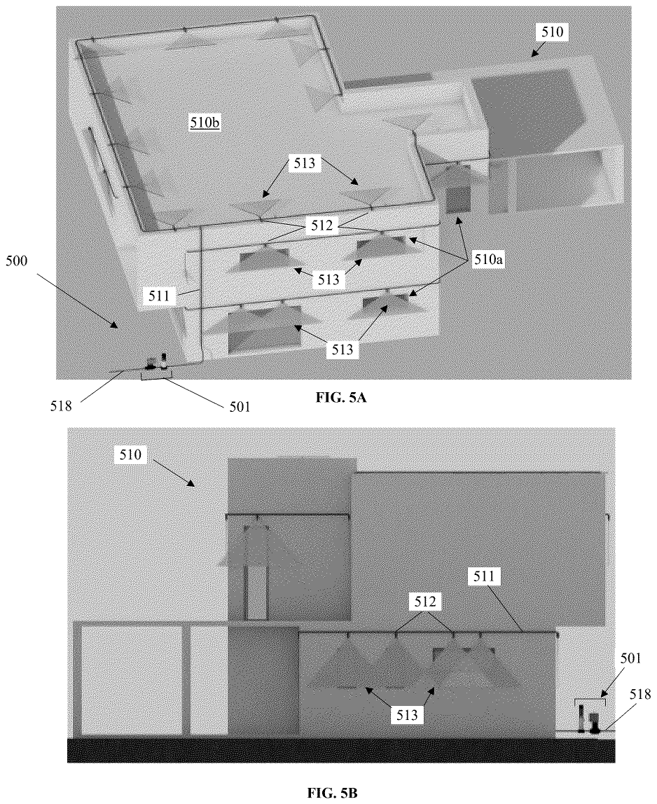

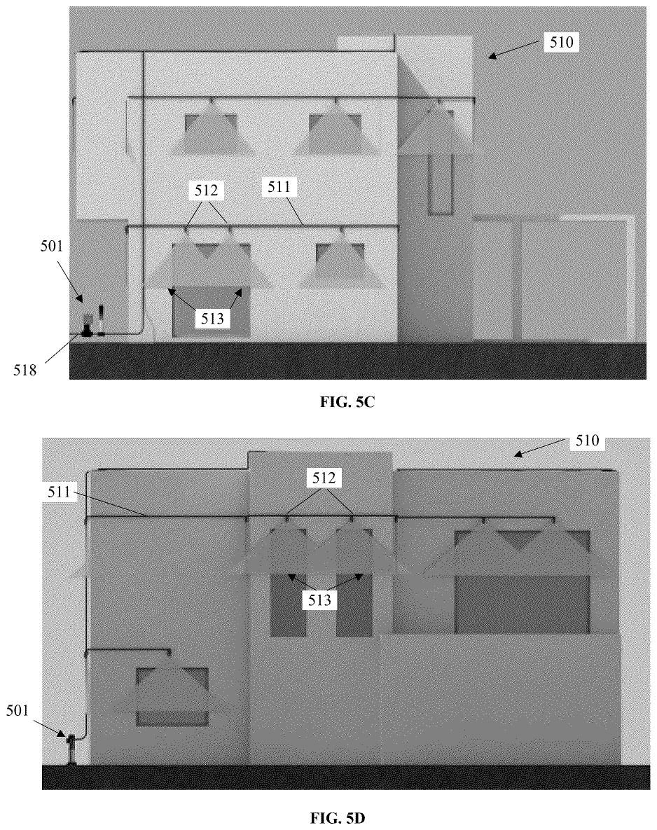

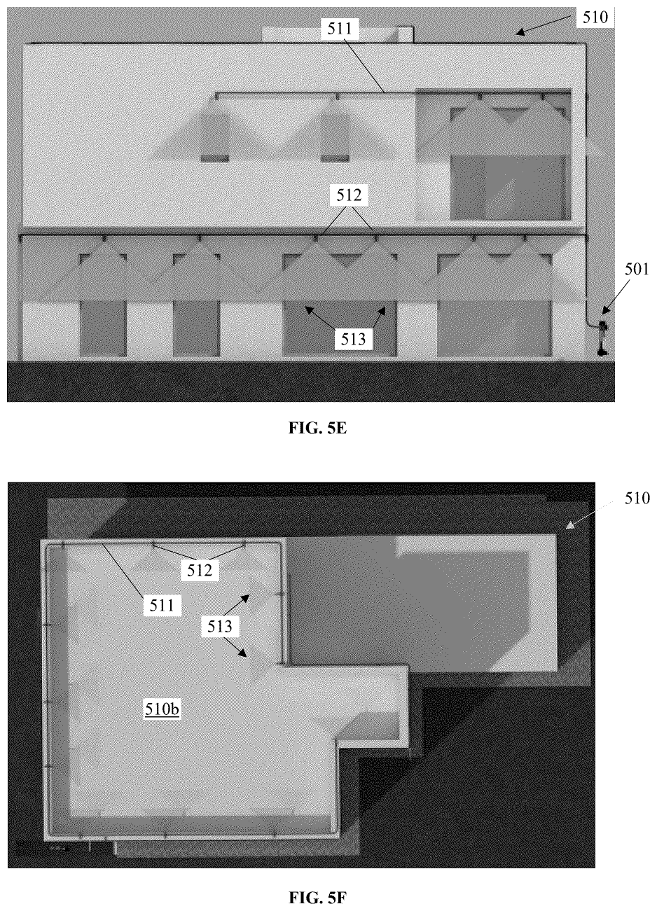

It should be understood that in addition to the disclosed main control base 101 shown in FIG. 1A-1B, the disclosed fire suppression system may also comprise a plurality of sensors for detecting fires. In an embodiment, such as the fire suppression system embodiment shown in FIGS. 5A-5F, the fire suppression system may comprise five flame detectors (“flame sensors”) configured to detect flames, wherein each flame detector is configured to monitor a corresponding facade or the roof of the building on which it is installed. Each flame detector may be configured to detect the appearance of fire from inside the corresponding building through the windows (e.g., a flame detector disposed on the exterior of a building may be suitably configured to see a flame burning inside the building through the window) or on the roof and facades from the embers brought by the wind. Each flame detector may be configured such that upon detection of a flame, the control pump 104 may be started and the solenoid valve 106b may be rapidly actuated (e.g. within two seconds) from a closed position to an open position such that water from the municipal water source (or another viable source) may be rapidly pumped through the distribution line to corresponding nozzles. Each nozzle may be configured to produce a flat water curtain over a corresponding window, door, or portion of the roof, for fire suppression, which may be maintained as long as a flame detector detects a flame. Once the flame detectors can no longer detect a flame, the solenoid valve 106b may be closed and the control pump 104 may be turned off, to conserve water and power. In an embodiment, this rapid actuation of the solenoid valve 106b and the control pump 104 may be done through the connection box 106a, wherein there is a relay and a current transformer 220/110v-12v, such that the solenoid valve 106b, the control pump 104, and the flame detectors are all powered and commands are issued between corresponding elements to facilitate reactive fire suppression during fires. In an embodiment, the main control base 101 may be configured to pump water from a water source (such as the water main of a building) through a distribution line to supply the described nozzles (“flat jet nozzles”) of the fire suppression apparatus with the necessary water pressure and flow rate to produce a sufficiently compact water curtains, as will be described in greater detail hereinbelow.

In an embodiment, the disclosed fire suppression apparatus may contain several main elements, namely a control pump 104 with expansion tank 105, a flame detector (such as a UV Themo vision detector), a solenoid valve 106b, connection box 106a with contact relay, flat jet pressure nozzles, small diameter copper pipes 15 mm and cables. Of these main elements, the water pump 104, expansion tank 105, solenoid valve 106b, connection box 106a with contact relay, and electrical supply may be provided as components of the main control base 101 of the fire suppression apparatus. In an embodiment, the main control base 101 of the fire suppression apparatus may be mounted in the house or garage depending on the route of the house water supply pipe.

FIG. 2 illustrates the bottom perspective view of a flame sensor 202 of a fire suppression apparatus, according to an aspect. In an embodiment, the disclosed fire suppression apparatus may be configured to operate automatically (e.g., produce water curtains over relevant locations) upon detection of a fire within a detection area, thus initiating the flow of water through the distribution line to the nozzles without human intervention. In order to allow for the automatic detection of a fire, the fire suppression apparatus may comprise a plurality of flame sensors 202, such as the detection camera 202 of FIG. 2. Each flame sensor 202 of a fire suppression apparatus may be in electrical communication with the main control base, such as main control base 101 of FIGS. 1A-1B, and configured to initiate operation of the pump and solenoid valve to begin pumping water through the fire suppression apparatus to the plurality of nozzles, such as nozzles 312 of FIG. 3. Water may be carried from a water source, through the main control base and the distribution lines 211 and to the plurality of nozzles, wherein the distribution line 211 may be disposed around the perimeter of a structure/building, as will be described in greater detail hereinbelow.

In an embodiment, the detection camera 202 of FIG. 2 may be in electrical communication with the connection box 106a of the main control base 101 FIG. 1A, wherein the connection box 106a is configured to be in electrical communication with the control pump 104 and the solenoid valve 106b. In said embodiment, the connection box 106a of FIG. 1B may be configured to facilitate electrical communication between the fire suppression system components outside of the main control case, such as the sensor cameras 202, and those disposed within the control case, such as the control pump and solenoid valve. In this way, the connection box may be configured to receive a signal from a sensor camera 202, and then send a signal to the solenoid valve to open and the control pump to operate to facilitate the distribution of water to each nozzle of the fire suppression apparatus. In an embodiment, the connection box 106a of the main control base may be configured to operate as a central controller of the fire suppression apparatus, wherein the connection box is configured to receive signal(s) from the sensor camera(s) 202 when a fire is detected and then actuate the solenoid valve (such as solenoid valve 106b of FIG. 1B) and pump (such as pump 104 of FIG. 1B) as necessary to deliver water to each nozzle through the distribution line. It should be understood that the connection box may comprise the necessary elements to facilitate this functionality as described herein, while also be configured to facilitate auxiliary functions, such as notifying the building owner and fire brigade upon detection of a fire, as will be described in greater detail herein.

In an embodiment, the flame sensors 202 may be a thermal imaging cameras or other suitable sensors configured to accurately detect the presence of a fire within a detection area, including but not limited to: thermal cameras, ultraviolet cameras, infrared cameras, etc. Each flame sensor 202 may be configured to quickly identify flames within its detection area. As will be described in greater detail, each flame sensor 202 may be positioned on the external surface (facade) of a building and aimed toward corresponding windows, doors, or portions of the roof, such that the entire exterior of the house (as well as part of the interior, viewed through windows and other transparent surfaces) is being monitored. As such, the observed detection areas may correspond to all of the potential surfaces of a structure from which a fire may escape. In this way, upon a fire breaching the structure, the flame sensors 202 may detect the fire, and the fire suppression apparatus may actuate the nozzles to begin suppressing the fire, thus preventing spread and growth of the fire. In an alternative embodiment, the flame sensors 202 may be positioned and configured in such a way as to detect a fire within the building prior to damage/destruction of windows and thus may utilize the spray of a nozzles to cool and protect windows, doors etc., prior to their destruction.

In an embodiment, each flame sensor 202 may be suitably positioned to detect a flame in proximity (e.g., within several feet) of the building and send a signal to the main control base to begin the flow of water to the nozzles upon said detection. In an embodiment, a flame within several feet of the building or closer may be understood to be “in proximity” to the building. In said embodiment, the flame sensors 202 may be positioned and suitably configured to observe the area immediately adjacent to/in proximity to the building, as well as the building itself. In an embodiment, each flame sensor 202 may be suitably configured and positioned to also view openings within the buildings, such as windows, to detect flames within the building.

FIG. 3 illustrates a bottom perspective view of distribution line 311 of a fire suppression apparatus, according to an aspect. As described hereinabove, the fire suppression apparatus may be configured to pump water through the distribution line 311 to supply a constant supply of pressurized water to a plurality of nozzles 312 during operation. As such, the main control base (such as main control base 101 of FIGS. 1A-1B), the supply line 311 and a plurality of nozzles 312 may be in fluid communication with each other. It should be understood that the main control base is configured to supply sufficient pressure to the water pumped through the distribution line 311 to ensure proper formation of water curtains from each nozzle 312, as will be described in greater detail hereinbelow.

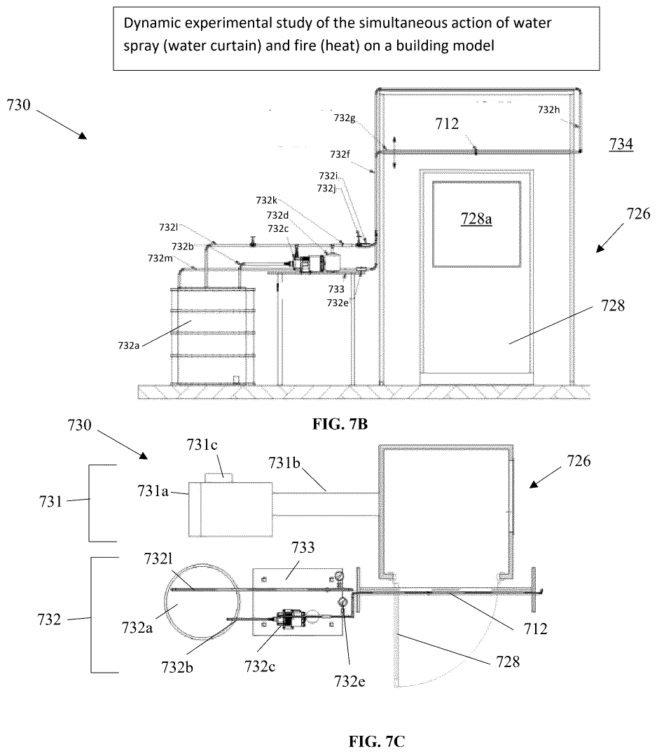

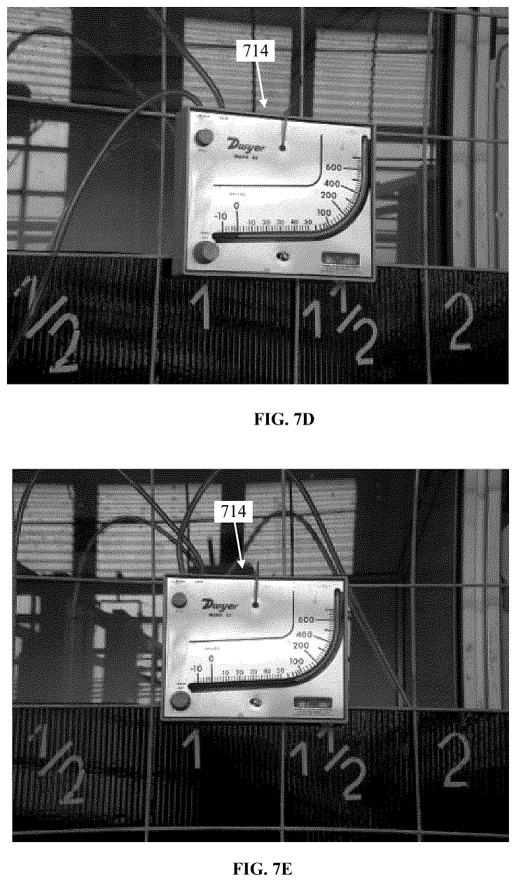

In order to prevent a fire from escaping from a burning structure, the nozzles 312 of a fire suppression apparatus may be placed near positions corresponding to potential escape routes for the fire from the building 310 (e.g., windows, doors, other openings, roofs, etc.). As seen in FIG. 3, nozzles 312 may be positioned above openings 310a within the buildings (e.g., windows and doors) to create a flat water curtain, such as flat water curtain 713 of FIGS. 7A-7B, to isolate the fire within the corresponding building 310 from the external environment. In doing this, the flow of oxygen into the burning building 310 may be slowed/prevented, thus helping to contain and control the fire, while preventing burning debris from escaping the openings 310a of the building 310.

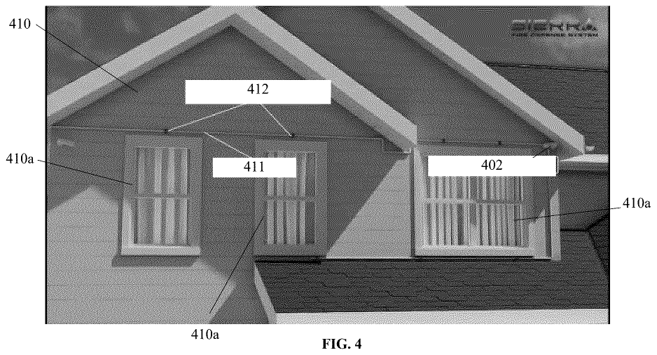

FIG. 4 illustrates the front perspective view of a building 410 having the fire suppression apparatus, according to an aspect. As can be seen in FIG. 4, the disclosed fire suppression apparatus may have a plurality of nozzles 412 in fluid communication with the distribution line 411, such that water pumped through the fire suppression apparatus may be distributed through the nozzles 412 for fire suppression. As described hereinabove, the fire suppression apparatus may further comprise at least one flame sensor 402, wherein each flame sensor 402 is suitably positioned and configured to detect a fire at a corresponding opening 410a or region of the attached building 410. Furthermore, each nozzle 412 may be positioned over a corresponding opening 410a in the building, such that upon actuation of each nozzle 412 a curtain of water is sprayed over the corresponding openings, preventing the escape and entrance of gases and the spread of fire between the internal environment of the building 410 and the external environment.

FIG. 5A-5F illustrate the top perspective, front, back, left, right and top views, respectively, of a building 510 having an embodiment of the fire suppression apparatus 500, according to an aspect. The disclosed building 510 of FIGS. 5A-5F has four facades and a terrace roof, and an area of 2500 sq ft. In an embodiment, a fire suppression apparatus 500 may comprise a main control base 501, a distribution line 511 in fluid communication with the main control base 501, a plurality of nozzles 512 in fluid communication with the distribution line 511, and at least one flame sensor, such as detection camera 202 of FIG. 2, in electrical communication with the main control base 501. The main control base 510 may be in fluid communication with a municipal water source, such as a water line 518, to supply a constant source of water to the fire suppression apparatus when needed. In an embodiment, upon a flame sensor detecting a flame, the flame sensor may send a signal to the main control base 501 to actuate a corresponding solenoid valve to open and operate the pump within the main control base 501 to send water through the distribution line 511 to the nozzles 512 for the generation of a water curtain 513 over each applicable opening 510a of the building 510.

In an embodiment, the distribution line 511 may be configured to engage with the building 510 such that a portion of the distribution line 511 is above each opening 510a in the building 510. This positioning of the distribution line 511 thus allows for suitable positioning of at least one nozzle 512 above each opening 510a in the building 510. By having at least one nozzle 512 above each opening 510a, upon actuation of the fire suppression apparatus 500, a curtain of water 513 may cover each opening 510a, as seen in FIGS. 5A-5F. In an embodiment, the distribution line 511 may be positioned above each opening 510a such that each nozzle 512 is about 30 cm above the top of the corresponding opening 510a. In an embodiment, this positioning of each nozzle 512 a fixed distance above a corresponding opening 510a allows for the curtain of water generated by the nozzle to suitably cover the corresponding opening, in the event of breakage during a fire, thus preventing or slowing proliferation of gases through the corresponding opening 510a. It should be understood that the generated curtain of water remains compact over a certain distance from the nozzle, such that gases may not travel through the water curtain over its compact region (e.g., the compact water curtain is impermeable to gases). For a building that is on fire, this allows for smoke and other gases to be trapped within the building, whereas fresh air is not allowed to travel into the building, thus helping slow the growth of the fire.

In an embodiment, the distribution line 511 may also be configured such that it allows for the positioning of at least one nozzle 512 on the roof 510b of the building 510. In said embodiment, a corresponding portion of the distribution line 511 may be disposed around the perimeter of the roof 510b, such that nozzles 512 in fluid communication with said portion of the distribution line 511 may be configured to spray water onto the roof 510b of the building 510 during a fire. Spraying the roof 510b of a building 510 may not only help to contain a fire trapped within the building 510, but may also prevent burning debris from external sources (e.g., debris from adjacent burning structures, burning debris carried by the wind) that may land on the roof 510b from setting the roof 510b of the building 510 on fire.

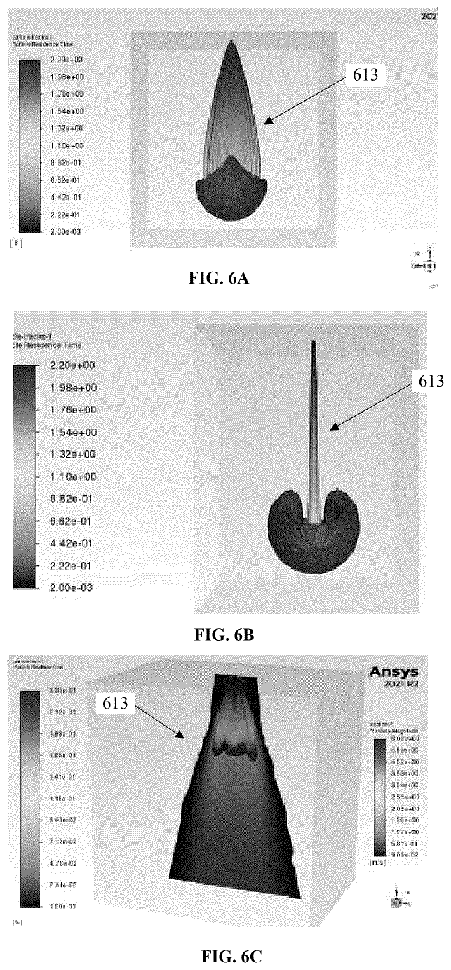

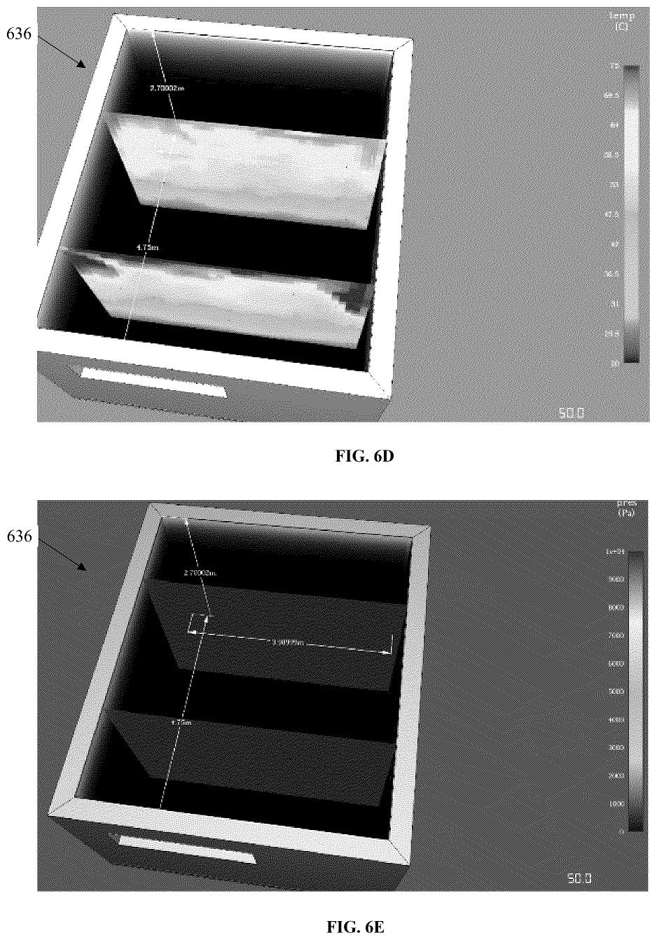

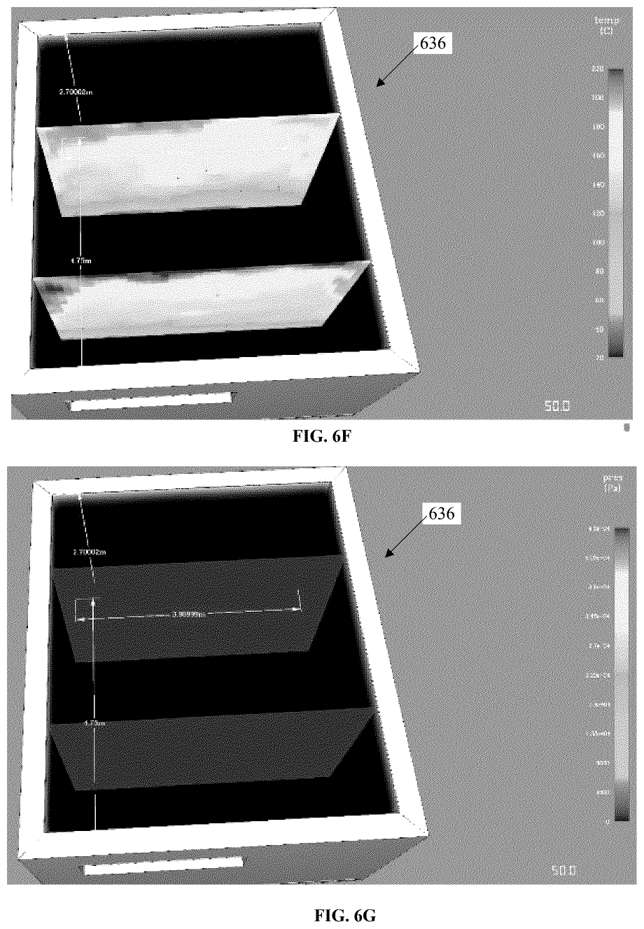

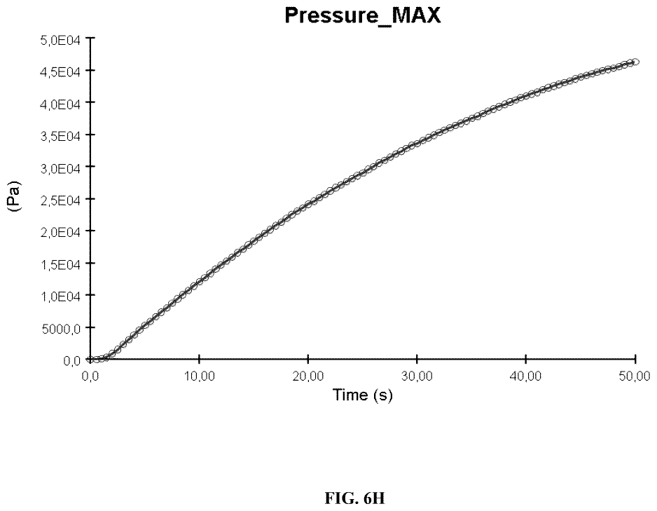

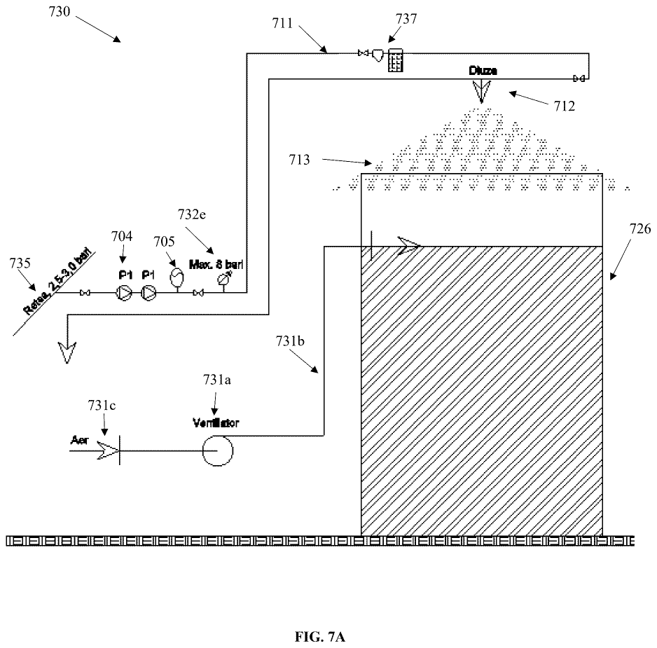

FIG. 6A illustrates a front view of a static simulation of nozzle operation for a static operation nozzle system, according to an aspect. FIG. 6B illustrates a side view of a static simulation of nozzle operation for a static operation nozzle system, according to an aspect. FIG. 6C illustrates a front perspective view of a static simulation of nozzle operation, according to an aspect. The disclosed figures of FIG. 6A-6C illustrate the static operation (nozzle system only) of a water spraying scheme (water curtain) on a model building (e.g., model building 726 FIG. 7A-7C). The produced water curtain 613 may be utilized in the containment of a fire within a burning structure, as will be elaborated upon in greater detail hereinbelow. The static simulations of FIG. 6A-6C were generated through the utilization of a simulation program, ANSYS FLUENT. As can be seen in FIG. 6A-6B, the simulated spray pattern may have a low residence time (values toward the bottom of the provided scale) at the top of the spray pattern and a high residence time (values toward the top of the provided scale) at the bottom of the spray pattern. In FIG. 6C, the spray pattern may have a high residence time region toward a center portion of the spray, surrounded by a low residence time region.

After analyzing the dispersion of a water curtain 613 over a 2 second period, it was found that it formed a single, concentrated flat pattern in a specific direction. Also, when the water curtain 613 had a shape like a truncated cone, it stopped widening after a certain distance and remained at a constant width. This is important to know when deciding how many nozzles to use to cover a certain area with glass windows, doors, etc. In an embodiment, the nozzles each form a flat water curtain 613, which is important for stopping fires from spreading when windows in a building are broken. It is also possible to utilize different nozzles with larger openings/different spray angles if needed, depending on the size of the opening being covered.

FIG. 6D illustrates a static temperature simulation of a 200 kW/m² heat load fire in a room 636 after 50 seconds, according to an aspect. FIG. 6E illustrates a static pressure simulation of a 200 kW/m² heat load fire in a room 636 after 50 seconds, according to an aspect. As seen in FIG. 6D, temperatures may be higher at the top of the simulated region and lower at the bottom of the simulated region. For FIG. 6E, the pressure value may be toward the top of the provided range scale throughout the entirety of the room. FIG. 6F illustrates a static temperature simulation of a 1000 kW/m² heat load fire in a room 636 after 50 seconds, according to an aspect. FIG. 6G illustrates a static pressure simulation of a 1000 kW/m² heat load fire in a room 636 after 50 seconds, according to an aspect. FIG. 6H illustrates a graph of pressure over time for the static pressure simulation of a 1000 kW/m² heat load fire in a room of FIG. 6G, according to an aspect. As seen in FIG. 6F, temperatures may be higher at the top of the simulated region and lower at the bottom of the simulated region. For FIG. 6G, the pressure value may be toward the top of the provided range scale throughout the entirety of the room. In determining suitable operating parameters for testing nozzle configurations, the conditions within a burning room were simulated using PyroSim, a fire simulation program.

The described temperature study was done starting with a hypothetical thermal load of a fire starting from 200 kW/m², which then was increased to 1000 kW/m². As can be seen in FIG. 6D-6E, for a simulated 200 kW/m² heat load fire burning within a room, which may represent the initial phase of a fire in a room 636, the temperature in said room 636 may get up to 75 degrees Celsius after 50 seconds which generates a pressure of 0.1 bar in the room 636. As can be seen in FIG. 6F-6G, for a simulated 1000 kW/m² heat load fire burning within a room 636, which may represent a later phase of a fire in a room 636, the temperature in said room may get up to 220 degrees Celsius after 50 seconds which generates a pressure of 0.45 bar in the room 636. These conditions during the later phase of a fire may result in the breaking of windows in the room 636, thus the spreading of flames within the room 636 to the external environment. The graph of FIG. 6H illustrates the increase in pressure within said room 636 for the burning of the 1000 kW/m² heat load fire, wherein the pressure quickly rises to 0.45 bar over a 50 second time span. This 0.45 bar pressure may be relevant for testing, as it may be utilized as a set point for pressure within a later described structure used to simulate a burning building (e.g., the model building 726 of FIG. 7A-7C) to ensure the suitable operation and function nozzles of the disclosed fire suppression system, even while the building is pressurized.

FIG. 7A illustrates a schematic diagram of a nozzle testing apparatus 730, according to an aspect. FIG. 7B illustrates the front view of a nozzle testing apparatus 730, according to an aspect. FIG. 7C illustrates the top view of a nozzle testing apparatus 730, according to an aspect. FIG. 7D illustrates the front view of a micromanometer prior to operating the nozzle testing apparatus 730, according to an aspect. FIG. 7E illustrates the front view of a micromanometer while operating the nozzle testing apparatus 730, according to an aspect.

In an embodiment, the disclosed nozzle testing apparatus (“nozzle testing device”) 730 may have a nozzle setup similar to that of a standard fire suppression apparatus, while also having a model building 726 utilized for measuring the performance characteristics of different nozzle embodiments while mounted in front of a pressurized opening. In the disclosed nozzle testing apparatus 730 embodiment, a manometer 714, such as micromanometer 714 of FIG. 7D-7E, may be in fluid communication with the model building 726 in order to provide accurate pressure readings for the environment within the model building 726.

In an embodiment, the nozzle testing apparatus 730 may comprise a water delivery system 732 in fluid communication with a corresponding nozzle 712, and an air delivery system 731 in fluid communication with a model building 726. In the nozzle testing apparatuses 730 disclosed herein, the water delivery system 732 may be configured to provide a water supply to a nozzle at a desired pressure to allow for proper testing, whereas the air delivery system 731 may be configured to provide airflow into the model building 726 to simulate the pressure conditions during a fire, to test the nozzle 712 using conditions that it would experience in the field during a fire.

In an embodiment, the water delivery system 732 may comprise a fluid reservoir 732a (or other suitable water source 735), an aspiration line 732b in fluid communication with the fluid reservoir 732a, a pump 732c in fluid communication with the aspiration line 732b, an expansion vessel 732d in fluid communication with the pump 732c, and a flow meter 732e in fluid communication with the pump 732c. In order to facilitate an adjustable height for an attached nozzle 712, the water delivery system 732 may further comprise a first flexible height connection 732f in fluid communication with the flow meter 732e, a nozzle support bar 732g in fluid communication with the first flexible height connection 732f, and a second flexible height connection 732h in fluid communication nozzle support bar 732g. As is understood, the nozzle support bar 732g may be configured to be in fluid communication with a corresponding nozzle 712, wherein the nozzle 712 may be selectively changed for testing. In the embodiment of FIG. 7B, the flexible height connections 732f, 732h and corresponding nozzle support bar 732g may be simplified to be described as portions of the distribution line 711 of the corresponding water delivery system 732. The water delivery system 732 may further comprise a manometer 723i in fluid communication with the second flexible height connector 732h, a faucet/tap 732j in fluid communication with the manometer 732i, a one way valve 732k in fluid communication with the faucet/tap 732j and recirculation line 732l in fluid communication with the one way valve 732k and the fluid reservoir 732a. The water delivery system 732 may also further comprise a discharge line 732m in fluid communication with the fluid reservoir 732a and the pump 732c. In an embodiment, the flow meter 732e and pump 732c may be disposed on top of a support table 733 to provide them with suitable elevation for viewing/user interaction. In an embodiment, the water delivery system 732 may further comprise a filter 737 in fluid communication with the distribution line 711 and the nozzle 712, wherein the filter 737 is configured to filter out/eliminate possible impurities in the water that can block the nozzle 712 prior to being sprayed from the nozzle 712.

In an embodiment, the air delivery system 731 may comprise a fan 731a, an air intake 731c in fluid communication with the fan 731a, and an air flow pipeline 731b in fluid communication with the fan 731a and the model building 726. During testing of the attached nozzle 712, the fan 731a may be operated to emulate the air flow/pressure conditions that a nozzle attached to a building would experience during a fire (e.g., higher pressure within the model building 726, such that air flows out of the model building into the surrounding environment 734). As can be seen in FIG. 7B, the model building 726 may have a mobile wall 728 with an opening (“slot”) 728a toward its top to simulate a window, wherein pressurized air, as well as generated smoke, present within the model building 726 are configured to attempt to escape through the opening 728a, to determine how effective the generated water curtains are at containing the smoke and pressurized air. The opening 728a may be disposed a certain distance below the nozzle 712 attached to the nozzle support bar 723g, such that the height of the nozzle 712 above the opening 728a may be adjusted as necessary for testing based on flow rate, dispersion angle of nozzle 712, etc. In an embodiment, a device configured to generate smoke (not shown) may be disposed within the model building 726, wherein smoke may be generated during nozzle testing to determine how effective the produced water curtains are at containing the generated smoke.

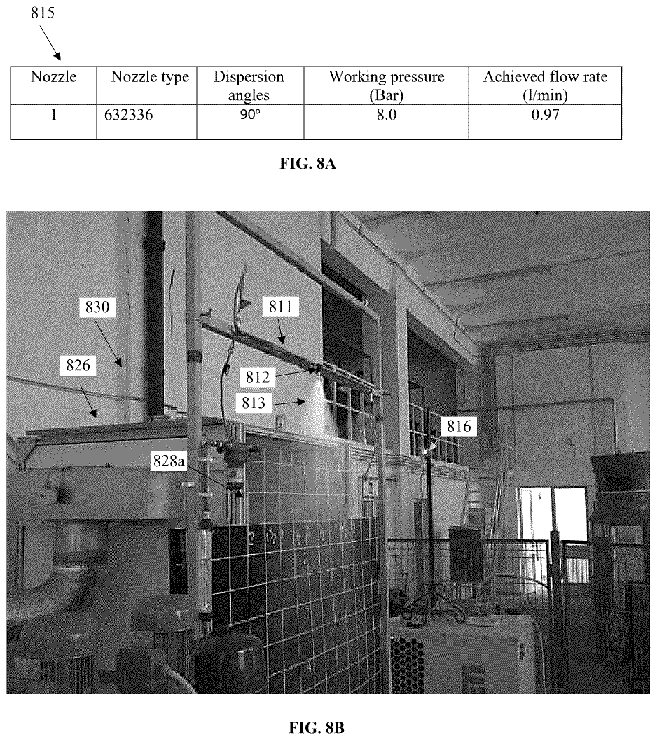

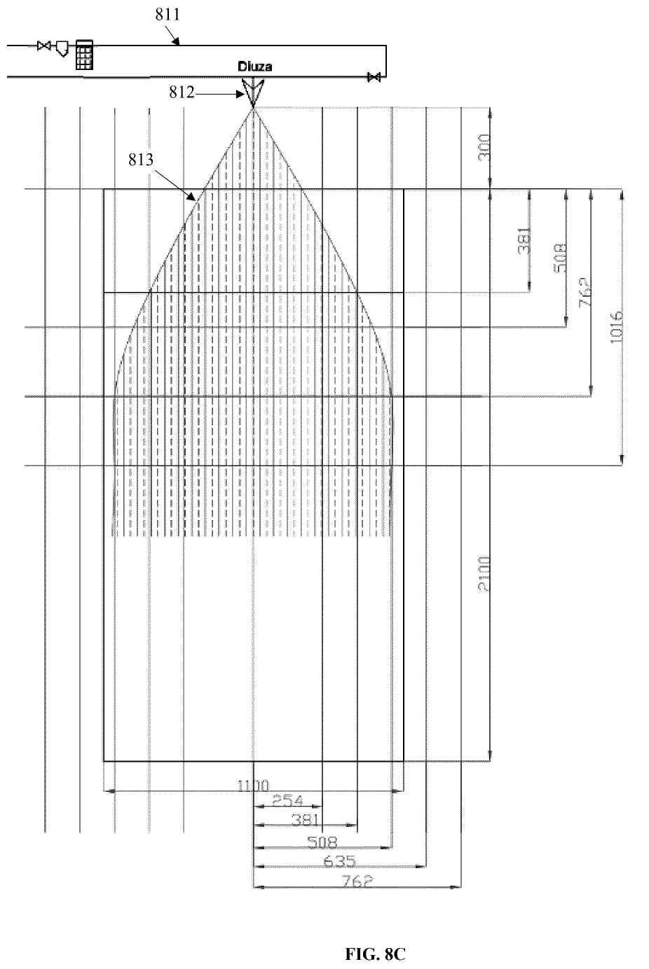

The disclosed model building 726 may be configured to simulate the pressure conditions present within a burning building during a fire. In an embodiment, the pressure established within the model building 726 during fan operation may be roughly equivalent to the combustion pressure of materials (wood, textiles, plastic, etc.) in a burning room 50 seconds after the fire starts, which may be a pressure of approximately 0.45 bar. As articulated by the micromanometer 714 of FIG. 7D-7E, the pressure inside the model building 726 before testing (as seen by micromanometer 713 of FIG. 7D) may be lower than the pressure inside the model building 726 during testing of the nozzles 712 (as seen by micromanometer 714 of FIG. 7E). With the movable wall 728 of the model building 726 in a closed position, a fan 731a in fluid communication with the model building 726 achieves an overpressure of 70 Pa inside the model building 726. After releasing the simulated opening area 728a in the facade of the model building 726, the static pressure inside the model building 726 decreases to 5 Pa. As such, the pressure within the model building may be adjusted through selective manipulation of the opening 728a. In an embodiment, the opening 728a may be adjusted to establish a pressure of 0.45 bar within the model building 726, a pressure consistent with the fire simulation of FIG. 6G. The different nozzles 712 evaluated using this nozzle testing apparatus 730 will be discussed hereinbelow. In the testing embodiments of FIG. 8A-12C below, the air velocity at the opening 731c is on average 2.0 m/s. As is understood, these values indicate an inward to outward air flow from the model building 726 into the external environment 734.

In an embodiment, the water pressure in the test facility reads between 2.5 and 8.0 bar. In the below described nozzle test embodiments of FIG. 8A-12C, the pressure supplied to the nozzles was between 7.4-8.0 bar. As will be described hereinbelow, a first, second, third, fourth and fifth nozzle embodiments were tested for the production of differently sized water curtains for the covering windows, doors, and other openings of a building during a fire. It should be understood that first, second, third, etc., designations utilized for the above described nozzles are not intended to indicate a particular order or arrangement of nozzles within a system, but merely to uniquely identify and differentiate each different nozzle embodiment tested herein. It should be understood that specific nozzles may be selected and positioned based upon the specifications of the window, door or other structure being protected. In an embodiment, nozzles having a smaller dispersion angle of about 90 degrees and a flow rate of about 0.9 L/min at a pressure of 8.5 bar may be configured for mounting and utilization on small windows, whereas nozzles having a greater dispersion angle of about 120 degrees and a flow rate of about 1.1-3.1 L/min may be configured for mounting and utilization on larger windows and roofs.

FIG. 8A illustrates a table for a first nozzle 812 being tested on the nozzle testing apparatus 830, according to an aspect. FIG. 8B illustrates the side perspective view of the first nozzle on the nozzle testing apparatus 830 producing a water curtain 813, according to an aspect. FIG. 8C illustrates a nozzle spray diagram for the first nozzle, according to an aspect. As described herein above, a nozzle testing apparatus 830 may be configured to utilize a first embodiment of a spray nozzle, referred to herein as the first nozzle 812. In an embodiment, this first nozzle 812 may be in fluid communication with a distribution line 811 such that a constant supply of pressurized water may be supplied to the first nozzle 812 to produce a water curtain 813. In an embodiment, the first nozzle 812 may be positioned above an opening 828a of the model building 826, such that gases/smoke leaving the model building 826 from the opening are trapped by the water curtain 813, preventing or slowing the escape of said gases/smoke from the model building 826. A laser 816 may be provided as part of the nozzle testing apparatus 830 to illuminate the produced water curtain 813, and smoke, thus aiding in the visualization and characterization of the produced water curtain 813.

As seen in FIG. 8A, in an embodiment, the first nozzle 812 has a dispersion angle of about 90 degrees, a working pressure of about 8 bar and an achieved flowrate of about 0.97 L/min. Under these conditions, the generated water curtain 813 for the first nozzle is shown in FIG. 8C. Based on the size of the produced water curtain 813 for the first nozzle 812, said first nozzle 812 is capable of providing a sufficiently sized water curtain 813 to cover a 60 cm wide window/opening, under the disclosed operating conditions. It should be noted that the measurements for the numbers provided in each of the nozzle spray diagrams (FIGS. 8C, 9C, 10C, 11C and 12C) are in millimeters.

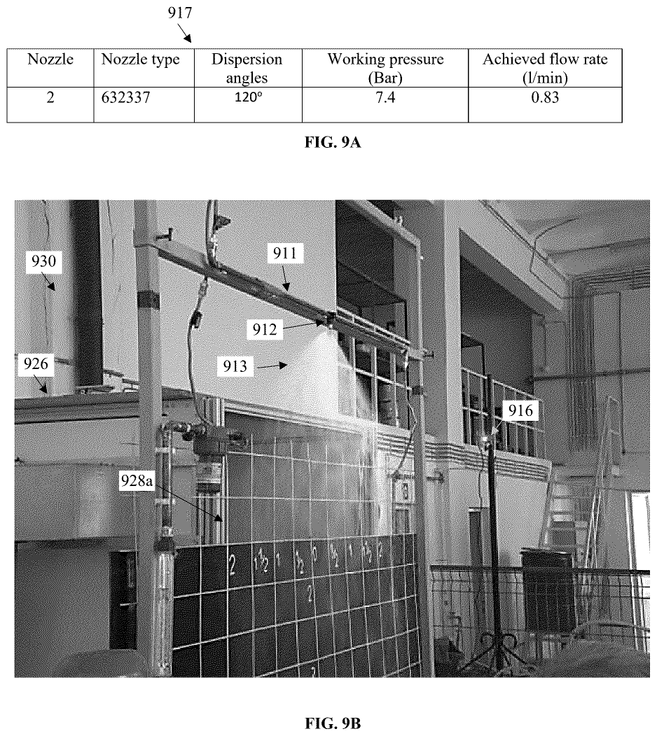

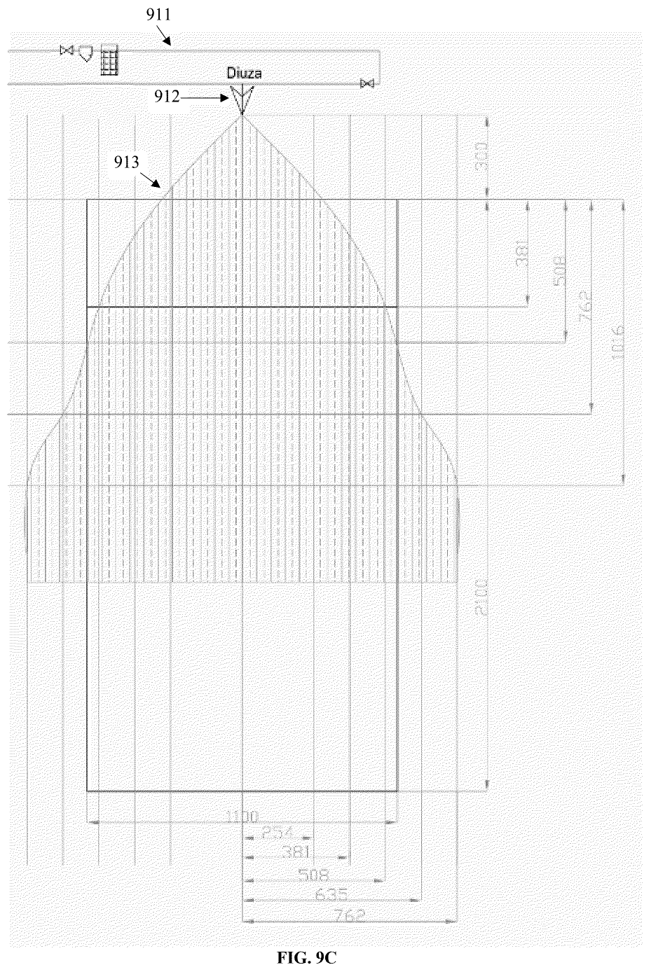

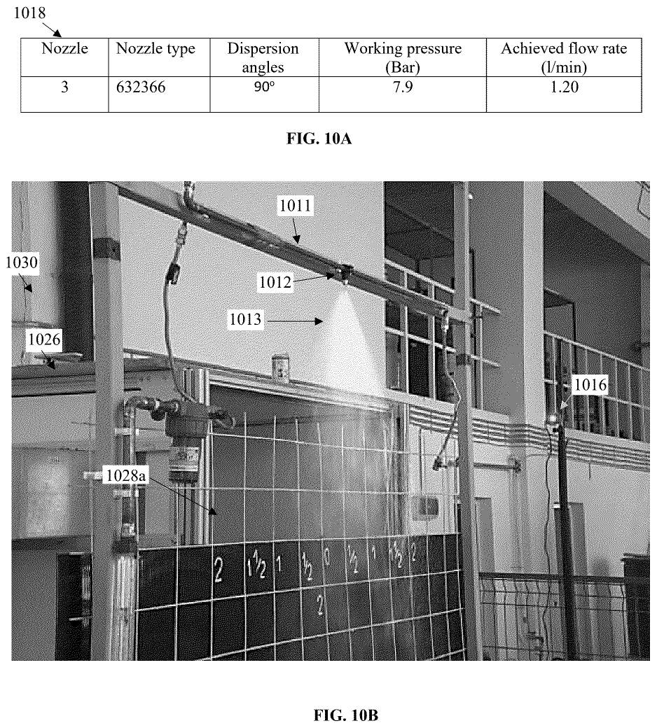

FIG. 9A illustrates a table for a second nozzle 912 being tested on the nozzle testing apparatus 930, according to an aspect. FIG. 9B illustrates the side perspective view of the second nozzle on the nozzle testing apparatus producing a water curtain, according to an aspect. FIG. 9C illustrates a nozzle spray diagram for the second nozzle, according to an aspect. As described herein above, a nozzle testing apparatus 930 may be configured to utilize a second embodiment of a spray nozzle, referred to herein as the second nozzle 912. In an embodiment, this second nozzle 912 may be in fluid communication with a distribution line 911 such that a constant supply of pressurized water may be supplied to the second nozzle 912 to produce a water curtain 913. In an embodiment, the second nozzle 912 may be positioned above an opening 928a of the model building 926, such that gases/smoke leaving the model building 926 from the opening 928a are trapped by the water curtain 913, preventing or slowing the escape of said gases/smoke from the model building 926. A laser 916 may be provided as part of the nozzle testing apparatus 930 to illuminate the produced water curtain 913, and smoke, thus aiding in the visualization and characterization of the produced water curtain 913.

As seen in FIG. 9A, in an embodiment, the second nozzle 912 has a dispersion angle of about 120 degrees, a working pressure of about 7.4 bar and an achieved flowrate of about 0.83 L/min. Under these conditions, the generated water curtain 913 for the second nozzle is shown in FIG. 9C. Based on the size of the generated water curtain 913 for the second nozzle 912, said second nozzle 912 is capable of providing a sufficiently sized water curtain 913 to cover a 120 cm wide window/opening, under the disclosed operating conditions.

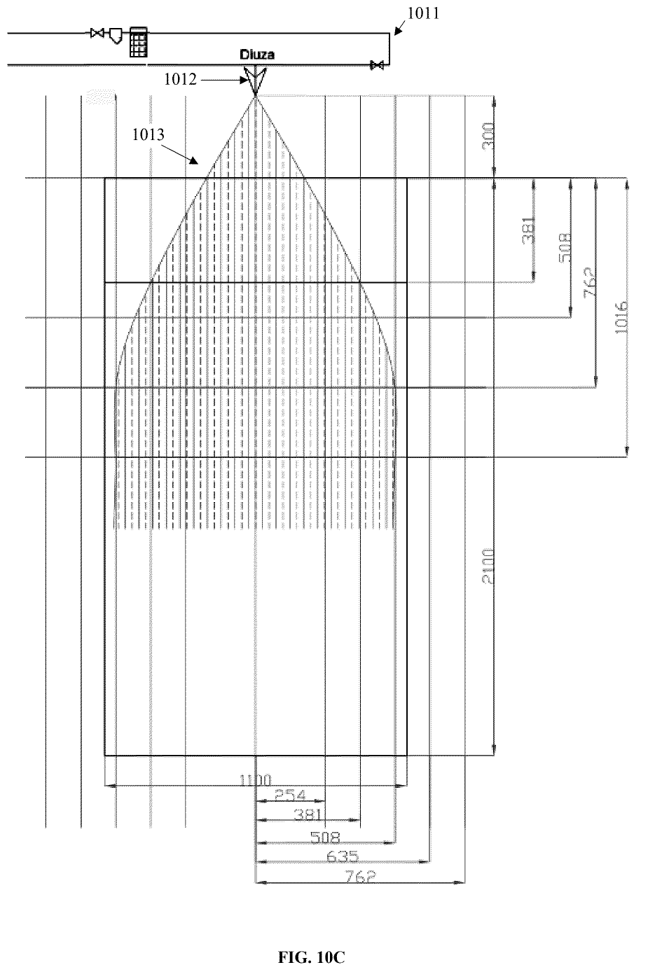

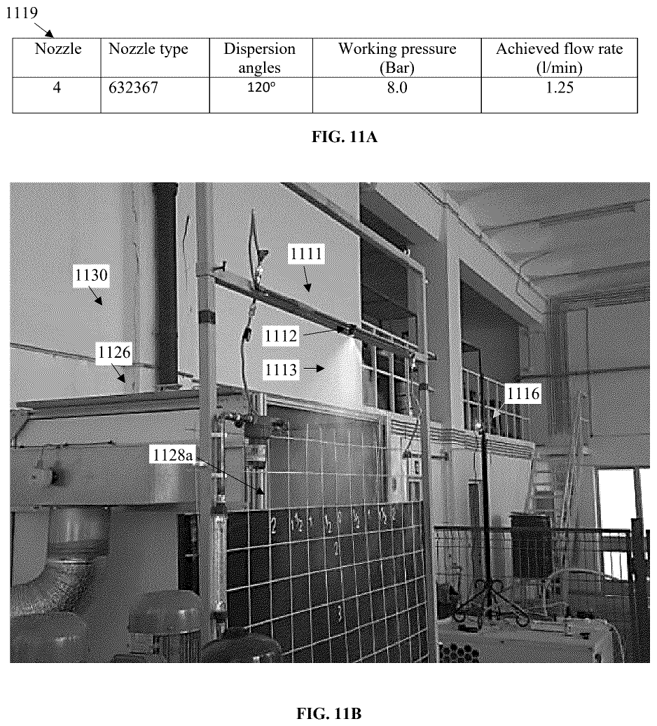

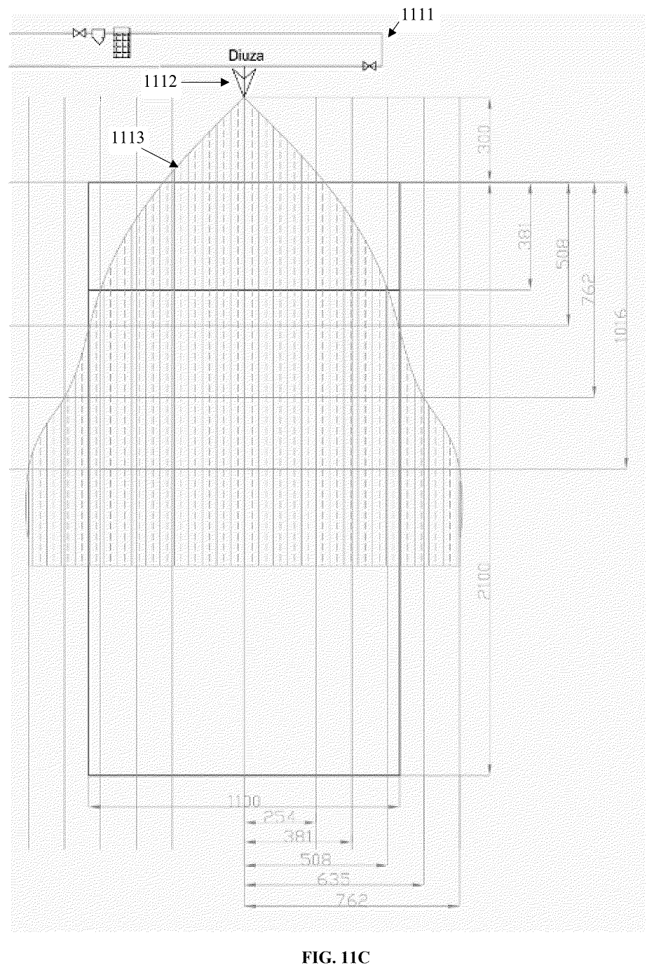

FIG. 10A illustrates a table for a third nozzle 1012 being tested on the nozzle testing apparatus 1030, according to an aspect. FIG. 10B illustrates the side perspective view of the third nozzle on the nozzle testing apparatus producing a water curtain, according to an aspect. FIG. 10C illustrates a nozzle spray diagram for the third nozzle, according to an aspect. As described herein above, the nozzle testing apparatus 1030 may be configured to utilize a third embodiment of a spray nozzle, referred to herein as the third nozzle 1012. In an embodiment, this third nozzle 1012 may be in fluid communication with a distribution line 1011 such that a constant supply of pressurized water may be supplied to the third nozzle 1012 to produce a water curtain 1013. In an embodiment, the third nozzle 1012 may be positioned above an opening 1028a of the model building 1026, such that gases/smoke leaving the model building 1026 from the opening 1028a are trapped by the water curtain 1013, preventing or slowing the escape of said gases/smoke from the model building 1026. A laser 1016 may be provided as part of the nozzle testing apparatus 1030 to illuminate the produced water curtain 1013, and smoke, thus aiding in the visualization and characterization of the produced water curtain 1013.

As seen in FIG. 10A, in an embodiment, the third nozzle 1012 has a dispersion angle of about 90 degrees, a working pressure of about 7.9 bar and an achieved flowrate of about 1.20 L/min. Under these conditions, the generated water curtain 1013 for the third nozzle is shown in FIG. 10C. Based on the size of the generated water curtain 1013 for the third nozzle 1012, said third nozzle 1012 is capable of providing a sufficiently sized water curtain 1013 to cover a 60 cm wide window/opening, under the disclosed operating conditions.

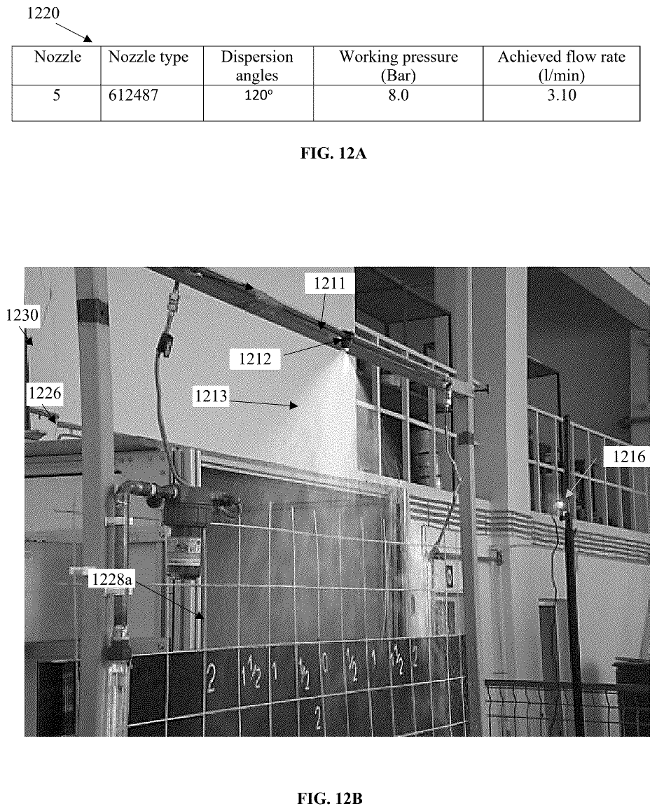

FIG. 11A illustrates a table for a fourth nozzle 1112 being tested on the nozzle testing apparatus 1130, according to an aspect. FIG. 11B illustrates the side perspective view of the fourth nozzle on the nozzle testing apparatus producing a water curtain, according to an aspect. FIG. 11C illustrates a nozzle spray diagram for the fourth nozzle, according to an aspect. As described hereinabove, the nozzle testing apparatus 1130 may be configured to utilize a fourth embodiment of a spray nozzle, referred to herein as the fourth nozzle 1112. In an embodiment, this fourth nozzle 1112 may be in fluid communication with a distribution line 1111 such that a constant supply of pressurized water may be supplied to the fourth nozzle 1112 to produce a water curtain 1113. In an embodiment, the fourth nozzle 1112 may be positioned above an opening 1128a of the model building 1126, such that gases/smoke leaving the model building 1126 from the opening 1128a are trapped by the water curtain 1113, preventing or slowing the escape of said gases/smoke from the model building 1126. A laser 1116 may be provided as part of the nozzle testing apparatus 1130 to illuminate the produced water curtain 1113, and smoke, thus aiding in the visualization and characterization of the produced water curtain 1113.

As seen in FIG. 11A, in an embodiment, the fourth nozzle 1112 has a dispersion angle of about 120 degrees, a working pressure of about 8.0 bar and an achieved flowrate of about 1.25 L/min. Under these conditions, the generated water curtain 1113 for the fourth nozzle is shown in FIG. 11C. Based on the size of the generated water curtain 1113 for the fourth nozzle 1112, said fourth nozzle 1112 is capable of providing a sufficiently sized water curtain 1113 to cover a 120 cm wide window/opening, under the disclosed operating conditions.

For the first 812, second 912, third 1012 and fourth nozzle 1112 embodiments of FIG. 8A-11C, the corresponding water curtain 813, 913, 1013, 1113 is compact up to a distance of 130 cm from (e.g., below) the nozzle. Beyond this value, the water curtain remains in the form of a curtain, but the dispersion is greater, resulting in a biphasic medium. Furthermore, smoke leaving the model building through the corresponding opening 828a, 928a, 1028a, 1128a is taken up by the water curtain and sent to the bottom (e.g., sent downward). This indicates that fire and smoke leaving the room through the void of the opening does not pass through the formed water curtain. It should be understood that a water curtain is most effective at preventing the passage of smoke, fire and burning debris in regions wherein said water curtain is compact.

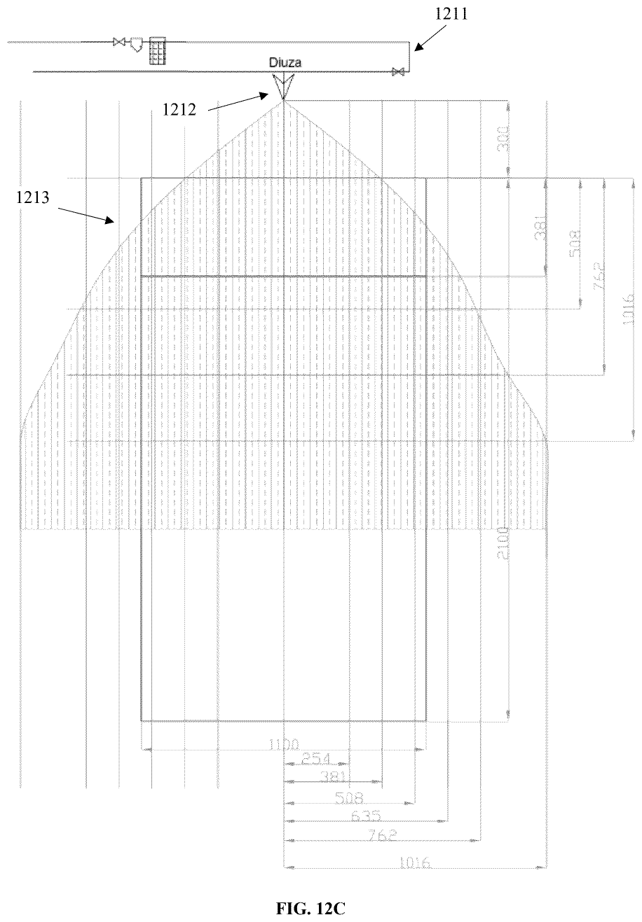

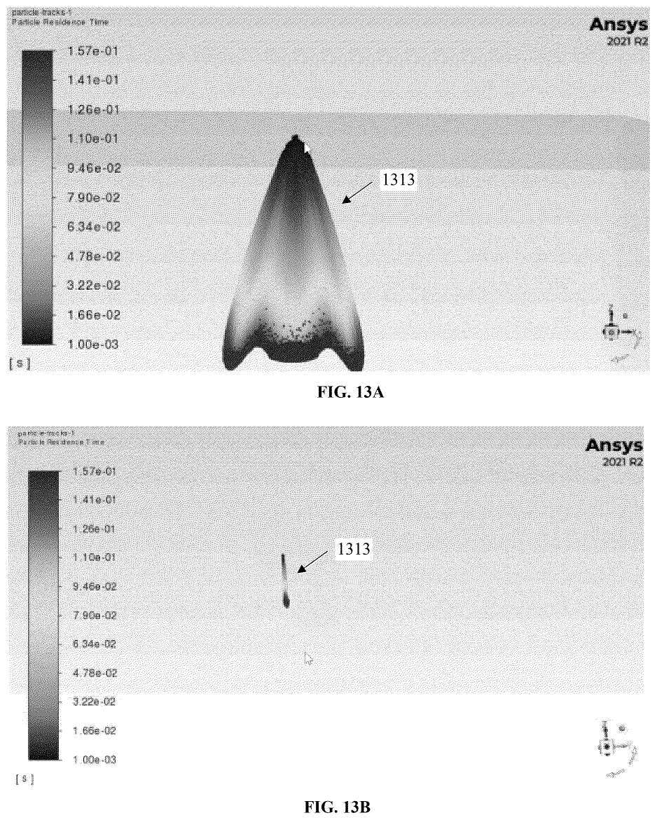

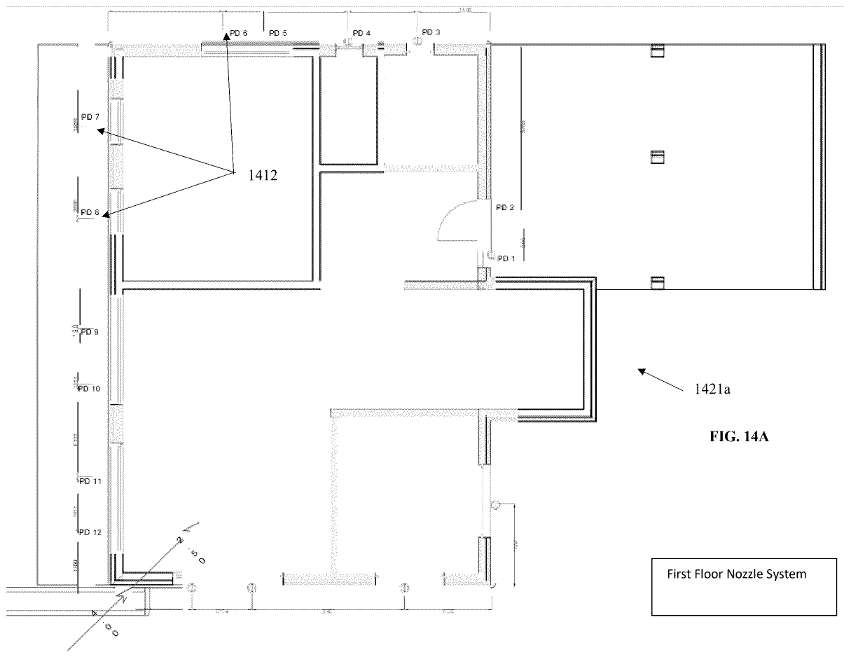

FIG. 12A illustrates a table for a fifth nozzle 1212 being tested on the nozzle testing apparatus 1230, according to an aspect. FIG. 12B illustrates the side perspective view of the fifth nozzle on the nozzle testing apparatus producing a water curtain, according to an aspect. FIG. 12C illustrates a nozzle spray diagram for the fifth nozzle, according to an aspect. As described herein above, a nozzle testing apparatus may be configured to utilize a fifth embodiment of a spray nozzle, referred to herein as the fifth nozzle 1212. In an embodiment, this fifth nozzle 1212 may be in fluid communication with a distribution line 1211 such that a constant supply of pressurized water may be supplied to the fifth nozzle 1212 to produce a water curtain 1213. In an embodiment, the fifth nozzle 1212 may be positioned above an opening 1228a of the model building 1226, such that gases/smoke leaving the model building 1226 from the opening 1228a are trapped by the water curtain 1213, preventing or slowing the escape of said gases/smoke from the model building 1226. A laser 1216 may be provided as part of the nozzle testing apparatus 1230 to illuminate the produced water curtain 1213, and smoke, thus aiding in the visualization and characterization of the produced water curtain 1213.

As seen in FIG. 12A, in an embodiment, the fifth nozzle 1212 has a dispersion angle of about 120 degrees, a working pressure of about 8.0 bar and an achieved flowrate of about 3.10 L/min. Under these conditions, the generated water curtain 1213 for the fifth nozzle is shown in FIG. 12C. Based on the size of the generated water curtain 1213 for the fifth nozzle 1212, said fifth nozzle 1212 is capable of providing a sufficiently sized water curtain 1213 to cover a 120 cm wide window/opening, under the disclosed operating conditions. The 120 degrees dispersion angle and high flow rate of the fifth nozzle 1212 creates a compact water curtain 1213 over a larger width and a longer length than the second and fourth nozzles 912, 1112 of FIG. 9A-9C and 11A-11C, respectively.

Similarly to the above-described nozzles, the fifth nozzle 1212 is configured to create a water curtain 1213 that sends the smoke leaving the model building 1226 through the opening 1228a to the bottom of the water curtain, thus slowing or preventing the proliferation of gases and flames. This indicates that fire and smoke leaving the room through the void of the opening 1228a does not pass through the water curtain 1226.

As is understood, one or more of the above nozzle types may be utilized in a fire suppression apparatus, based on the characteristics and sizes of the openings present on the building. As disclosed hereinabove, water traveling through a distribution line of a fire suppression apparatus may be sprayed out of a corresponding nozzle to create a corresponding water curtain. It should be understood that the specifications of a nozzle may be modified in accordance with the opening/surface it is configured to protect. In an embodiment, a narrower window may be sufficiently covered by a nozzle having a dispersion angle of about 90 degrees. In contrast, it may be preferred to utilize nozzles having greater dispersion angles when trying to provide a water curtain over larger surfaces, such as the roof of a building or a larger window. It should be understood that the fire suppression apparatus is suitably configured to provide the necessary pressure to each nozzle to produce the desired water curtain over each opening in the building. In an embodiment, each of the above described nozzles of FIG. 8A-12C is configured to generate a sufficiently compact water curtain to prevent the proliferation of smoke/gases from an opening in a building to the external environment (and/or vice-versa) though the water curtain, as described herein. In said embodiment, each nozzle may be configured to generate a water curtain having a compact region, wherein said compact region of the water curtain (referred to as a compact water curtain) is configured to be impermeable to gases, such that a compact water curtain covering an opening in a building is configured to prevent gases, smoke, flames, etc., from travelling through the opening in either direction (e.g., from inside to outside the building or outside to inside the building).

In an embodiment, nozzles having a dispersion angle of about 90 degrees may be configured to provide a compact water curtains over a window up to 60 cm wide. In another embodiment, nozzles having a dispersion angle of about 120 degrees may be configured to provide a compact water curtain over a window up to 120 cm wide. As disclosed hereinabove, the distance (and width) over which the formed water curtain remains compact and thus is most capable of preventing the proliferation of smoke through itself, is also influenced by flowrate, wherein greater flowrates are typically configured to produced taller and wider water curtains with taller and wider compact areas.

As articulated above, a compact water curtain is configured to prevent the proliferation of fire and gases through the openings in a building. In an embodiment, while a building has an internal fire and the fire suppression apparatus operating (e.g., the nozzles are producing water curtains), the smoke leaving the building through the top gap of an opening is carried down by the corresponding water curtain and sent to the bottom of the water curtain. Again, this indicates that fire and smoke leaving the room through the corresponding opening does not pass through the compact water curtain. As such, the spread of fire through the opening to adjacent structure is thus slowed or prevented.

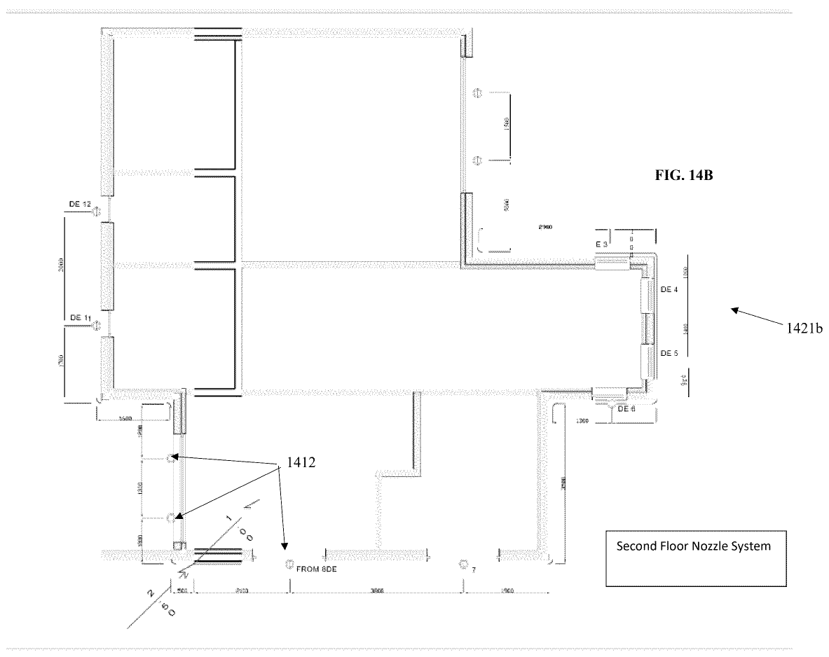

FIGS. 13A-13B illustrate the residence times for a water curtain 1313 sprayed from a nozzle from the front and side views, respectively, according to an aspect. As a nozzle sprays water to create the above-described water curtain 1313, the formed water curtain 1313 may have a particular shape. As seen in FIG. 13A-13B, the water curtain 1313 formed by one of the nozzles of the fire suppression apparatus may produce a water curtain having a “flat conical shape” having a narrower width at the nozzle that broadens as it travels further from the nozzle. As can be seen in FIG. 13A-13B, the residence times may be highest (values toward the top of the provided scale) at the bottom of the water curtain, and lowest (values toward the bottom of the provided scale) at the top of the water curtain.

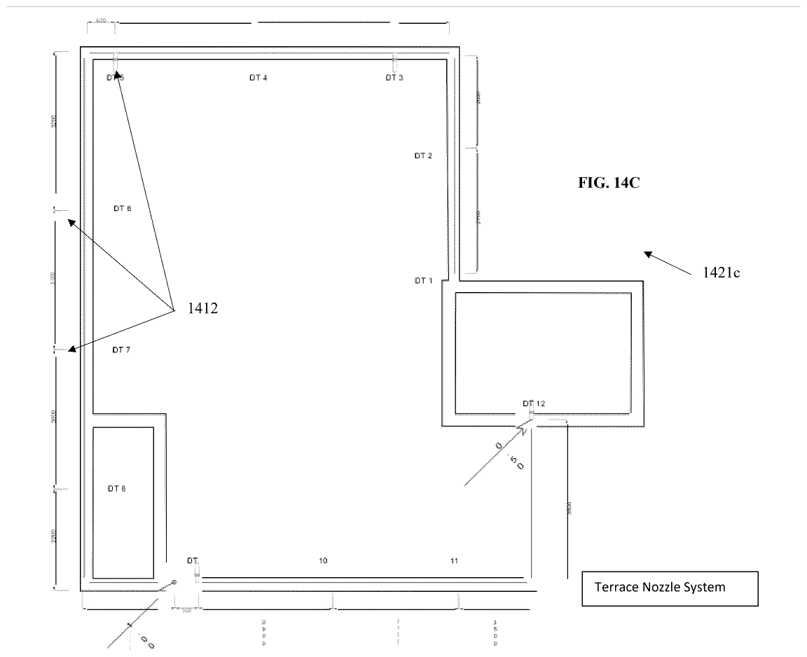

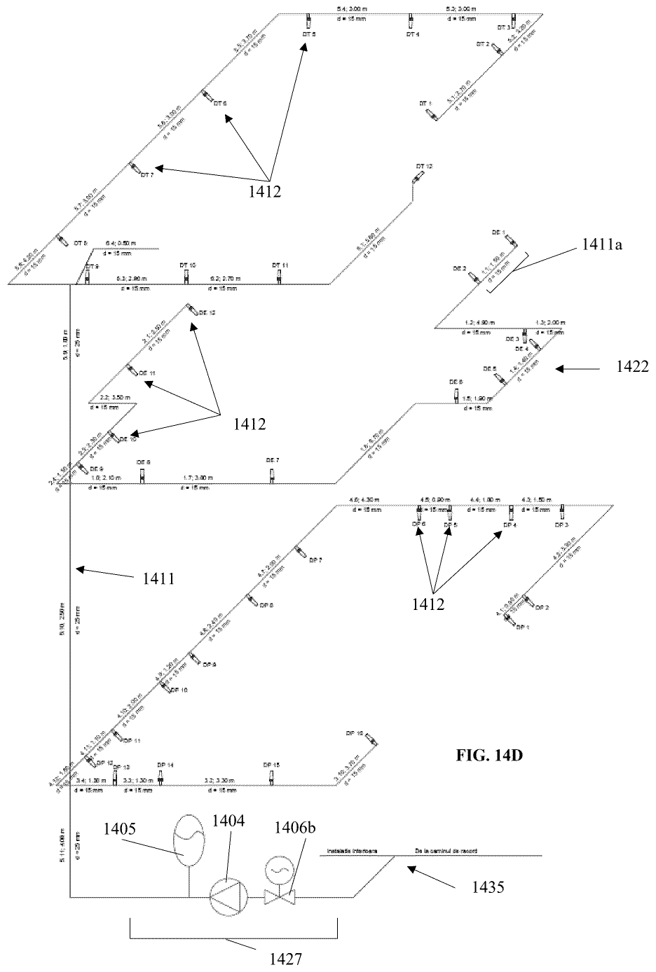

FIG. 14A illustrates the 1st floor of an experimental configuration for testing the fire suppression apparatus, according to an aspect. FIG. 14B illustrates the 2nd floor of an experimental configuration for testing the fire suppression apparatus, according to an aspect. FIG. 14C illustrates the 3rd floor of an experimental configuration for testing the fire suppression apparatus, according to an aspect. FIG. 14D illustrates a pipe diagram of the experimental configuration of the fire suppression apparatus of FIGS. 14A-14C, according to an aspect.

In the final phase, flat jet nozzles 1412 with a dispersion angle of 120 degrees and a flow rate of about 1 l/min at a working pressure of about 5 bar were chosen for use within the fire suppression apparatus embodiment of FIG. 14A-14D. The test building chosen for the study needed a total of 40 nozzles 1412:16 nozzles for the first floor 1421a, 12 nozzles for the second floor 1421b, and 12 nozzles for the terrace (roof) 1421c. In an embodiment, the nozzles 1412 are placed above the windows/doors at a distance of about 30 cm from the top of the window/door frame. Depending on the shape of the facade, the distance between the top of the opening and the nozzle 1412 can be modified so as not to affect the building architecture. Furthermore, the distance between the nozzles 1412 was calculated so that the formed water curtains have a cumulative width equal to the width of the corresponding gap/opening. For example, when an opening/gap is too large to be covered by the water curtain of a singular nozzle 1412, two nozzles 1412 may be placed close enough to each other to allow for the merging of their generated water curtains into a larger water curtain (as seen by the nozzles 512 and water curtains 513 of FIG. 5E), thus allowing the larger opening/gap to be sufficiently covered by a pair nozzles 1412. It should be noted that greater quantities of nozzles (e.g., more than 2 nozzles) may also be positioned such that their generated water curtains are combined into a larger continuous, compact water curtain, depending on the size of a corresponding opening that needs to be covered.

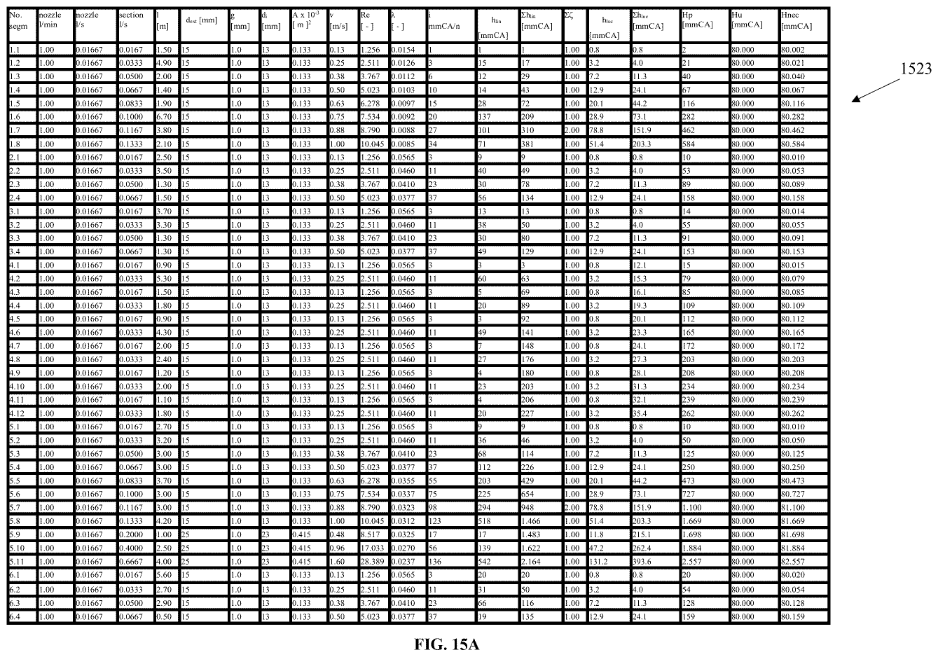

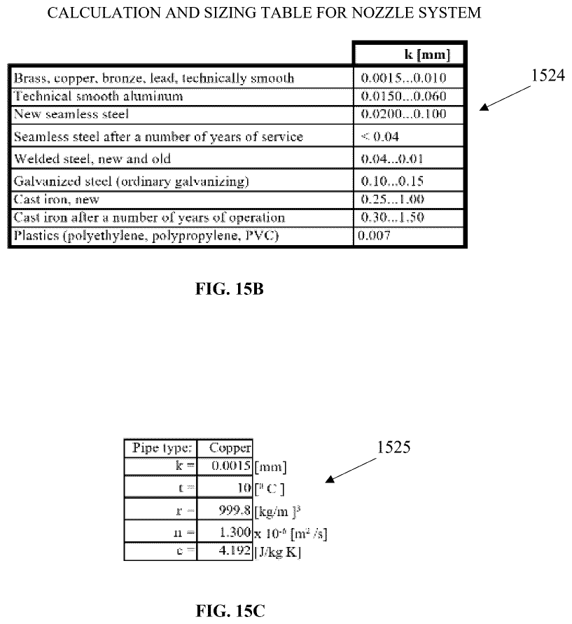

In an embodiment, a pumping station 1427 connected to the indoor plumbing supply pipe of the building is used to supply water to the fire suppression apparatus, operating at Pₙₒₘ=2 bar. In an embodiment, the pumping station 1427 may be or otherwise comprise a main control base, such as main control base 101 of FIG. 1A-1B, wherein said main pumping station comprises a solenoid valve 1406b in fluid communication with a municipal water network 1435, a pump 1404 in fluid communication with the solenoid valve 1406b and an expansion tank 1405 in fluid communication with the pump 1404, wherein the pumping station 1427 is configured to selectively pump water from the municipal water network 1435 into the distribution line 1411 and out through the nozzles 1412. In an embodiment, the connection between the pumping station 1427 and the indoor plumbing supply line has a diameter of 1″. The pumping station 1427 is provided with a pump with a minimum flow rate of 40 l/min (flow rate resulting from the operation of the nozzles at a pressure of 8 bar) and a maximum working pressure of 10 bar. The pump is protected against hydraulic shocks by an 8-liter expansion vessel. In front of the pump (e.g., between the pump 1404 and the municipal water supply 1435) there is a solenoid valve 1406b configured to be controlled by thermal imaging cameras (flame sensors) mounted on the facades of the corresponding structure. When a flame is visible through the doors or windows, the thermal imaging cameras (flame sensors) transmit the order to the main control base that operates the pump. In the embodiment of FIG. 14A-14D, the entire pumping station 1427 is installed in a technical room. As seen in FIG. 14D, each length of the distribution line 1411 disposed between nozzles 1412 or other elements may be referred to as a “segment”, such as segment 1.1 1411a, wherein the lengths and characteristics of each segment are shown in FIG. 15A.

In an embodiment, water is sent to the nozzles 1412 through a copper pipe (e.g., the distribution line 1411) with Pₙₒₘ=10 bar and diameters of 15×1 mm for the branches and 25×1 mm for the vertical column and connection to the pumping station 1427.

As described for the fire suppression apparatus embodiment above, under the analyzed conditions, the utilization of water spraying installations (e.g., nozzles) limits fire spreading to the neighboring buildings from the burning building by limiting the entrainment of flames and embers by air currents and the pressure created by the combustion of materials in the burning building. This creates the prerequisites to limit the fire spreading in condominiums wherein houses are close to each other and helps to isolate the fire until the arrival and intervention of the firefighters. Due to the fact that this fire suppression apparatus is provided with flame sensors, such as thermal imaging cameras, on all facades, the fire suppression apparatus solves an important issue for buildings located in regions with frequent vegetation fires, as the fire suppression system is configured to automatically start the flow of water through the nozzles installed on the roof and on all facades when a thermal imaging camera or other fire sensor detects the early stage of the fire propagated by wind-borne embers.

The nozzles of the fire suppression apparatus are automatically triggered by controlling the electric valve that powers the pump when the thermal imaging cameras transmit a signal corresponding to a detected flame to the main control base. Additionally, the fire suppression apparatus may be configured to automatically stop the flow of water to the nozzles once the flame sensors detect that the fire is gone. In the disclosed embodiment of FIG. 14A-14D, a mandatory condition of this particular system is the existence of a water source (network), such as the provided municipal water main for a building, at a minimum pressure of 2 bar and electricity to power the elements of the main control base, including the pump and solenoid valve, and the flame sensors. In alternative embodiments, alternative sources of water and power may be utilized in accordance with the needs of the application. The entire fire suppression apparatus may be supplied as a “kit” with all the necessary parts needed for installation on typical houses or can be designed and supplied as a one-off model for other types of houses.

FIGS. 15A-15C illustrate tables of the pipe specifications of the fire suppression apparatus configuration of FIG. 14A-14D, according to an aspect. In table 1523 of FIG. 15A, the length, diameter, area, etc., of each segment (e.g., segment 1.1, 1.2, 1.3, etc.) of the distribution line 1411 of the fire suppression apparatus identified in FIG. 14D are provided. It should be understood that the specifications in table 1523 have general relevance for sizing a standard fire suppression system kit for a house up to 2500 sq ft., and was calculated in such a way that for the 40 nozzles mounted throughout a 113 meter route of pipe, the flow rates and pressure at all nozzles are sufficient to generate the corresponding compact water curtains described in FIG. 8A-12C, depending on the nozzles selected.

Table 1524 of FIG. 15B illustrates a table of roughness coefficients, k, which may be utilized in determining the desired material to utilize for specific configuration of the fire suppression apparatus. Table 1525 of FIG. 15C illustrates flow parameters for copper pipe, which may be utilized for the distribution line of the disclosed fire suppression apparatus of FIG. 14A-14D. In an embodiment, copper may be selected as a suitable material for the distribution line, such as distribution line 1411 of FIG. 14D, as copper may have an ideal roughness, suitable resistance to high pressures, and be easy to mount and cover with decorative elements of building facades without affecting the architecture of the corresponding building.

The disclosed fire suppression apparatus was based on a Program Theme within the theme research contract content stage, with phase 1 including the establishment of the flat water jet nozzles scheme with sprayed water on the selected building model (as described in FIG. 7A-12C) and phase 2 including the simulation of the operation (in static mode only) of the nozzles scheme with a sprayed water curtain on the selected house model. Stage two Phase I included simulation (in static mode) of the action of the fire near the windows and doors and stage two Phase 2 included Dynamic simulation of the simultaneous action of sprayed water and fire on the house model phase. Phase 3 included establishing the final spraying scheme with sprayed water and preparing the necessary materials and equipment.

This last phase was concluded when the research in the laboratory was completed and research proceeded to the phase of making the prototype on a wooden house, such as building 310 as seen in FIG. 3, with an area of 1350 SQFT (sq ft.) made of fir logs. In the laboratory, as can be observed from the presentation study articulated in the testing configurations of FIG. 7A-12C, the corresponding nozzle testing apparatus 730 comprised a water delivery system 732 which was used for pumping water at different flow rates and pressures measured in different stages, an air delivery system 731 configured to create a pressurized model building 726 using a fan to generate pressure similar to the combustion pressure of the materials in the house in case of fire and a window frame support above an opening 728a in the model building 726 for engagement with a copper pipe and the flat jet nozzle. From the analysis of the required flow and pressure hydraulic parameters correlated with the combustion pressure resulting from the burning of the materials in the room, the types of nozzles needed to create the flat water blade/water curtain to overcome the pressure of combustion (e.g., have the water curtain remain compact and prevent smoke from passing through, despite the pressure in the model building) were identified, as described above. Thus, the fire can be isolated without the possibility of its propagation to the roof of the house or to other houses in the immediate vicinity.

In an embodiment, from the hydraulic calculation of the linear and local pressure losses along the route of a copper pipe installation for the selected house model, the requirements for the corresponding fire suppression apparatus were determined. In said embodiment, the corresponding fire suppression apparatus required 25 ft. of copper pipe with a diameter of 1″ and 346 ft. of copper pipe with a diameter of 0.6″. With regards to nozzles, the fire suppression apparatus embodiment also included 33 flat jet nozzles made to order by HENNLICH-Germany with a maximum flow of 1 liter per minute, maximum pressure of 10 bars, and angle 120-degree spray angle, brass spray nozzle with R ¼ clamps, and 10 flat jet nozzles from the same manufacturer with a maximum flow of 1 liter per minute, maximum pressure 10 bars and a 90-degree spray angle, made of brass with clamps on the pipe of 0.6″ copper above the glazed spaces, windows and doors.

In the above-described embodiment, a total flow rate of approximately 45 liters per minute at the optimal pressure of 8.5 bar in the laboratory was required to create a flat curtain of water at the least favorably located nozzle (e.g., where the pressure is lowest). In an embodiment, this optimal pressure may be provided or otherwise ensured by a GRUNDFOS-CMBE 3-93 pump. Water may be fed into the pump directly from a public water pipe network located in the house, such as a water main, having a diameter of 1″, through a normally closed solenoid valve, as detailed herein above. In an embodiment, the fire suppression apparatus may utilize TAKEX-FS 5000E flame sensors as the flame sensors, wherein the TAKEX-FS 5000E flame sensors may be configured to detect flames both inside (through the windows/openings) and outside (outside the windows/openings) the building. In said embodiment, the TAKEX-FS 5000E flame sensors may be configured to detect flames as small as those produced from a standard lighter (e.g., a cigarette lighter) within 2 seconds of the flame being generated. When properly mounted, each TAKEX-FS 5000E flame sensor can cover a maximum area of 1076 SQFT of house facade or roof, such that the entirety of the hereinabove described 1350 SQFT wooden house may be suitably monitored by a total of six TAKEX-FS 5000E flame sensors.

In an embodiment, a fire suppression system kit was installed on a house made of wooden logs having an area of approximately 1350 sq ft., such as the building 310 of FIG. 3. In said embodiment, the fire suppression system kit comprises a main control base (such as main control base 101 of FIG. 1A-1B), 2 UV flame detectors, about 60m of copper pipes (15 mm-25 mm diameter) and approx. 20 nozzles, which included 4 different types of nozzles for windows, 2 different types nozzles for doors and one type of nozzle for the roof. The presence of a flame was simulated with a gas lamp from inside/outside the windows and from outside to the wooden walls. The installed fire suppression system worked properly and activated in two seconds from the generation of the flame, wherein the flame detector gave a signal to the solenoid valve which started the pump and sent the pressurized water to the 20 nozzles, which created a flat water curtain over the entire surface of the windows, doors and the roof. Upon disappearance of the flame from the gas lamp, the flame detector immediately actuated the closing of the solenoid valve and the stopping of the pump, thus ensuring excess water/electricity is not wasted.

Once a flame sensor of the fire suppression apparatus, such as flame sensor 202 of FIG. 2, detects a flame, the corresponding flame sensor of the fire suppression apparatus may issue a command/send a signal to open the solenoid valve, such as solenoid valve 106b of FIG. 1B, and to operate the pump, such as pump 104 of FIG. 1B, to raise the pressure of the water supplied by the water main to 9 bar (or another suitable operation pressure) for distribution of water through a corresponding distribution line, such as distribution line 311 of FIG. 3, of the fire suppression apparatus. In an embodiment, the connection box, such as connection box 106a of FIG. 1B may be in electrical communication with the flame sensors, solenoid valve, and the pump, such that the connection box acts as an intermediary element between the flame sensors and the solenoid valve and pump. In said embodiment, the connection box may function as an electrical hub element within the main control base. Simultaneously to the distribution of water through the distribution lines, the nozzles of the fire suppression apparatus, such as nozzles 312 of FIG. 3, will begin creating water curtains that will isolate fire(s) disposed within the building and/or extinguish fire(s) brought to the facade/roof of the building from external sources. If the flames are extinguished (e.g., the flame sensor can no longer detect any flames), said flame sensor may automatically command the closing of the solenoid valve and stopping of the pump, thus turning off the water flow through the distribution line to the nozzles. It should be understood that the solenoid valve may only be closed off if none of the flame sensors of a fire suppression apparatus can detect a fire. The fire suppression apparatus may also be configured to trigger a telephone alarm to the owner of the building and the fire brigade/fire station to notify relevant parties in the event that a fire is detected.

In an embodiment, the main control base may comprise suitable hardware to trigger a telephone alarm to notify an owner of the building and a fire brigade upon detection of a fire. In an embodiment, this suitable hardware may be a component of the connection box, such as connection box 106a of FIG. 1B, or any other suitable structure configured to receive a signal from the flame sensors upon detection of a fire. This suitable hardware may comprise communications devices that utilize phone lines similar to that of a land-line telephone, a cellular device configured to send a telephone alarm without use of phone lines, or any other suitable communication method capable of sending the owner of the building and the fire brigade/station a suitable notification to alert them to the presence of a fire at the corresponding building. As such, the fire suppression system may be configured to allow the main control base to trigger a telephone alarm to notify the owner of the building and a fire brigade upon detecting a fire in proximity to the building.

In an embodiment, each element of the fire suppression apparatus, including the described main control base 101 of FIG. 1, can be delivered prefabricated in the form of a kit (e.g., a SIERRA-FIRE DEFENSE SYSTEM), wherein the kit is configured for satisfying the fire detection/fire suppression needs of houses ranging from 1000 sq ft-2700 sq ft. In an embodiment, the disclosed kit may cost a maximum of $10,000, wherein assembly and installation may take a maximum of 30-36 hours. For convenience and ease of access to supplemental materials, the disclosed fire suppression apparatus kit may be sold through construction material stores. As is understood, the fire suppression apparatus may be associated with a building in a suitable manner to facilitate the proper function of each element described herein. For example, in an embodiment, the main control base may be disposed inside or outside of the house, depending on the specific configuration of the fire suppression apparatus. In an embodiment, each flame sensor may be attached to an exterior surface of the building for suitable positioning to monitor the exterior of the building. In an embodiment, each nozzle may be attached to the building and positioned a suitable distance above each opening in the building to create a compact water curtain over said opening. It should be noted that alterations to element positioning and configuration may be implemented as needed within an application, as long as fire suppression system functionality is maintained.

As disclosed hereinabove, the disclosed fire suppression apparatus is configured to reduce the risk of fire spreading from one building to another before the fire brigade arrives. The operation of the nozzles may also be configured to cool the windows of a building using the produced water curtains, thus preventing (or greatly reducing the likelihood of) the windowpanes breaking, which in turn helps prevent the spread of the flames towards the roof and nearby structures, as well as reduces the influx of additional air/oxygen. Furthermore, the water curtains may also protect the attached building by defending it against fire from the external environment, as embers and burning debris that contact the roof/facade of the building may be detected and quickly extinguished before igniting the building. Furthermore, the fire suppression apparatus may be configured for automated operation, wherein the fire suppression apparatus may be activated rapidly and begin producing water curtains upon detection of a fire, and deactivated to stop producing water curtains after the fire can no longer be detected, thus helping to minimize water consumption and power use, all without human intervention. The fire suppression apparatus may be further configured to alert firefighters of the detected fire, to allow them to respond quickly to the fire as needed. As is understood, the fire suppression apparatus may be provided to users in the form of a modular kit having prefabricated elements, wherein the kit is quick and easy to install at a reasonable cost and may be utilized on both old and new houses.

The herein disclosed nozzles may provide several advantages over conventional water sprinkler devices, such as the herein disclosed nozzles being configured to create a compact water curtain for controlling the flow of gases and flames and utilizing a lower flow rate to do so, thus consuming less water while suppressing a fire. In an embodiment, the disclosed fire suppression system may be configured to extinguish/suppress a fire while only connecting to and utilizing the house's water supply pipe, thus avoiding the need for an additional water supply tank. As disclosed hereinabove, various nozzle configurations have been tested, each of which is configured to generate a corresponding water curtain having specific dimensions based on system pressure and flow rates. Depending on the size of the window/opening of a building, a different nozzle may be selected, based on minimizing the water flow rate (and thus overall water consumption) while providing a sufficiently sized compact water curtain for the suppression and containment of fire, smoke, and gases. In an embodiment, a fire suppression apparatus may utilize a plurality of nozzles to cover as large a surface of the house as possible, while minimizing flowrates at a high operating pressure through the utilization of small diameter pipes for its distribution lines. As is understood, the disclosed fire suppression system may be well suited for installation on buildings in crowded neighborhoods wherein neighboring houses are only separated by small distances. The capability of the disclosed fire suppression apparatus to isolate a fire within a burning structure, while simultaneously protecting neighboring structures from said fire, makes the disclosed fire suppression apparatus particularly well-suited high-density housing environments, such as densely packed cities and other urban areas.

As is understood, the fire suppression system is configured to perform a series of steps in order to protect a building from fires and/or prevent or slow fires from escaping from or encroaching upon a building. In an embodiment, this method of operating the fire suppression system may comprise the steps of: observing the building (using the fire sensors), detecting a fire in proximity to the building (using the fire sensors), sending a signal from the flame sensor(s) to the main control base, actuating the solenoid valve to selectively open fluid communication between the water source and the pump and starting pump operation to pump water through the distribution line to the nozzles, creating a corresponding water curtain from each nozzle of the plurality of nozzles, wherein each water curtain is configured to cover a corresponding portion of the building with a compact water curtain, detecting an absence of fire in proximity to the building (using the fire sensors), actuating the solenoid valve to close fluid communication between the water source and the pump and stopping pump operation to cease pumping water through the distribution line, and continuing observation of the building (using the fire sensors).

It should be noted that modifications to this method of operating the fire suppression system may be implemented as needed depending on the specific needs of a building. In an embodiment, instead of turning off water flow to the nozzles upon the fire no longer being detected by the flame sensors, the fire suppression system may continue generating water curtains for a period of time after no longer detecting a flame, prior to turning off, to ensure any residual flames that have not yet been detected do not reignite the structure after the fire has been mostly extinguished. Additionally, the method may further comprise the step of triggering a telephone alarm to notify an owner of the building and a fire brigade upon detecting a fire in proximity to the building. In an embodiment, triggering said telephone alarm may entail allowing the main control base to trigger a telephone alarm to notify an owner of the building and a fire brigade upon detecting a fire in proximity to the building, for embodiments wherein the telephone alarm functionality is enabled by the main control base.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. As used in this application, “and/or” means that the listed items are alternatives, but the alternatives also include any combination of the listed items.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. The terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A fire suppression apparatus configured to be associated with a building, the fire suppression apparatus comprising:
a main control base having:
a solenoid valve configured to be in fluid communication with a water supply;
a pump configured to be in fluid communication with the solenoid valve; and
a connection box in electrical communication with the solenoid valve and the pump;
a distribution line in fluid communication with the pump;
a plurality of nozzles in fluid communication with the distribution line, wherein each nozzle is configured to emit a water curtain; and
a plurality of flame sensors in electrical communication with the connection box, wherein each flame sensor of the plurality of flame sensors is configured to monitor a corresponding portion of the building and further configured to send a signal to the connection box to selectively open the solenoid valve and activate the pump upon detection of a flame, such that water from the water supply is selectively pumped through the distribution line and emitted through each nozzle.

2. The fire suppression apparatus of claim 1, wherein each nozzle of the plurality of nozzles is configured to generate a water curtain that remains compact to a distance of about 130 cm below the nozzle, wherein the compact water curtain is configured to be impermeable to gases.

3. The fire suppression apparatus of claim 1, wherein at least one nozzle of the plurality of nozzles is configured to create a compact water curtain over a corresponding opening of a building, such that gas flow through the corresponding opening of the building is prevented.

4. The fire suppression apparatus of claim 3, wherein the corresponding at least one nozzle configured to create a compact water curtain over a corresponding opening of the building is further configured to be positioned about 30 cm above the corresponding opening.

5. A fire suppression apparatus comprising:
a main control base having:
a solenoid valve configured to be in fluid communication with a water supply; and
a pump configured to be in fluid communication with the solenoid valve;
a distribution line in fluid communication with the pump;
a nozzle in fluid communication with the distribution line, wherein the nozzle is configured to emit a water curtain; and
a flame sensor in electrical communication with the main control base, wherein the flame sensor is configured to send a signal to the main control base to selectively open the solenoid valve and activate the pump upon detecting a flame, such that water from the water supply is pumped through the distribution line and emitted through the nozzle.

6. The fire suppression apparatus of claim 5, wherein the nozzle has a dispersion angle of 90 degrees.

7. The fire suppression apparatus of claim 5, wherein the nozzle is configured to generate a water curtain that remains compact to a distance of about 130 cm below the nozzle, wherein the compact water curtain is configured to be impermeable to gases.

8. The fire suppression apparatus of claim 5, wherein the flame sensor is an ultraviolet camera.

9. The fire suppression apparatus of claim 5, wherein the nozzle is disposed on a roof of a building and configured to spray a water curtain on the roof.

10. The fire suppression apparatus of claim 5, further comprising a plurality of additional nozzles, wherein at least one nozzle is configured to create a water curtain over a corresponding opening in a building.

11. The fire suppression apparatus of claim 10, wherein the corresponding at least one nozzle configured to create a water curtain over a corresponding opening in the building is further configured to be positioned about 30 cm above the corresponding opening.

12. The fire suppression apparatus of claim 5, further comprising an expansion tank in fluid communication with the pump.

13. The fire suppression apparatus of claim 5, further comprising a connection box in electrical communication with the solenoid valve, the pump and the flame sensor, wherein the connection box is configured to receive a signal from the flame sensor and send signals to the solenoid valve to be selectively opened and to the control pump to be selectively operated, such that to facilitate the distribution of water to each nozzle of the fire suppression apparatus upon detection of a fire.

14. The fire suppression apparatus of claim 5, wherein the water source is a municipal water supply.

15. A method for operating a fire suppression system associated with a building, the fire suppression system having: a main control base having: a solenoid valve configured to be in fluid communication with a water supply; and a pump configured to be in fluid communication with the solenoid valve; a distribution line in fluid communication with the pump; a nozzle in fluid communication with the distribution line, wherein the nozzle is configured to emit a water curtain; and a flame sensor in electrical communication with the main control base, wherein the flame sensor is configured to send a signal to the main control base to selectively open the solenoid valve and activate the pump upon detecting a flame, such that water from the water supply is pumped through the distribution line and emitted through the nozzle, the method comprising the steps of:
detecting a fire in proximity to the building;
sending a signal from the flame sensor to the main control base;
actuating the solenoid valve to selectively open fluid communication between the water source and the pump and starting pump operation to pump water through the distribution line to the nozzles;
creating a corresponding water curtain from each nozzle of the plurality of nozzles, wherein each water curtain is configured to cover a corresponding portion of the building with a compact water curtain;
detecting an absence of fire in proximity to the building; and
actuating the solenoid valve to close fluid communication between the water source and the pump and stopping pump operation to cease pumping water through the distribution line.

16. The method of claim 15, further comprising the step of allowing the main control base to trigger a telephone alarm to notify an owner of the building and a fire brigade upon detecting a fire in proximity to the building.

17. The method of claim 15, wherein detecting a fire in proximity to the building comprises detecting a fire within the building through an opening in the building.

18. The method of claim 15, wherein at least one nozzle of the plurality of nozzles is configured to create a compact water curtain over an opening in the building, wherein the corresponding compact water curtain remains compact to a distance of about 130 cm below the nozzle, wherein the compact water curtain is impermeable to gases.

19. The method of claim 18, wherein the compact water curtain over the opening in the building prevents gases from traveling through the corresponding opening in the building, thus preventing fire, smoke, embers, and debris from passing through the building opening.

20. The method of claim 15, wherein at least one nozzle of the plurality of nozzles is configured to spray a water curtain on a window, wherein the corresponding water curtain sprayed on the window is configured to cool the window to protect the window from shattering during a fire.
